(19) United States
(12) Patent Application Publication
(10) Pub. No.: US 2004/0052987 A1
(43) Pub. Date: Mar. 18, 2004

(54) Paper based retortable can and method for making same

(76) Inventors: Shankara R. Shetty, Milford, OH (US); Thomas Z. Fu, Milford, OH (US); Vivek Rohatgi, Loveland, OH (US); Ashok Adur, Cincinnati, OH (US)

Correspondence Address: Frederick H. Gribbell, FREDERICK H. GRIBBELL,LLC, Suite 120, 10250 Alliance Road, Cincinnati, OH, 45242, US

(21) Appl. No.: 10/434,566

(22) Filed: May 9, 2003

Related U.S. Application Data
(60) Provisional application No. 60/410,207, filed on Sep. 12, 2002.

(51) Int. Cl. B32B 1/08

(52) U.S. Cl. 428/34.2; 428/36.91; 156/203

(57) ABSTRACT

An improved retortable can is provided in which a primary structural element is a layer of paper or paperboard, which is laminated with a shielding layer on each side of the paper or paperboard core, and at least one barrier layer. The shielding layer is resistant to heat and moisture, and the barrier layer substantially reduces the transmission rate of oxygen, moisture, and flavor. A method for manufacturing the paper-based retortable can is also provided, which converts a web of the laminate material into tubes, either in a spiral-wrap (or a convolute) shape or a cylindrical shape that uses a side seal. An additional method for manufacturing paper-based retortable cans is provided in which two separate “half-structures” of laminate are joined in a spiral-wrap manufacturing step to form a single laminated structure with two paper/paperboard interior layers having an adhesive therebetween.

### TECHNICAL FIELD

The present invention relates generally to retortable cans and is particularly directed to retortable cans of the type which include a layer of paperboard material for mechanical strength. The invention is specifically disclosed as retortable can made of a laminated material with a middle paperboard layer, a barrier layer on each side of the middle layer, and an outer shielding layer covering each of the barrier layers.

### BACKGROUND OF THE INVENTION

Retortable cans are containers that can withstand a heating event, such as being subjected to steam for a time duration sufficient to kill bacteria. When steam is used in this manner, the container (i.e., the retortable can) essentially undergoes a sterilization process. Retortable cans are typically used to store food items, such as pet food, or canned fruits or vegetables.

In the past, most retortable cans have been made of metal. Such retortable cans were often made to be watertight, or waterproof, which would be especially necessary in the case of canned fruit or vegetables that would contain moisture in most circumstances. There are many watertight containers that are made to store food, although not every one of these conventional containers is also retortable with respect to being able to withstand a sterilization process using steam.

Some waterproof or watertight containers known in the prior art include a layer of paperboard or other paper substrate. For example, U.S. Pat. No. 3,406,891 (by Buchner) discloses a container for holding liquids, including foods. The container can be sterilized, and includes a wall structure having a layer of paper, an outer layer of aluminum foil, and an inner surface layer and outer surface layer of plastic material, such as polypropylene. The end walls of the container include a layer of aluminum foil that forms the outer layer, and the end walls also have an inner layer of polypropylene. The top and bottom covers (i.e., the end walls) are made of deep drawn metal foil with a U-form shaped rim portion that is telescoped over the container wall. A heat seal is established between the covers and the cylindrical walls. A metal foil provides sufficient strength to the weld seam and prevents a deterioration or deformation in the thermoplastic material of the cover, even though a slight softening in the plastic material may occur during a sterilization procedure.

Another waterproof container that includes paper material is disclosed in U.S. Pat. No. 4,679,724 (by Inagaki). The container has a wall made of a paper substrate which is surrounded by a double-wall of heat-shrinkable plastic film. Some of the embodiments of Inagaki use metal for the lids of the container, although some embodiments also show a paper lid that is covered by the plastic film. The plastic film preferably is made of a heat-shrinkable nylon that is laminated with polyethylene.

The Inagaki invention is designed to replace aluminum or steel cans, and the materials used are to be resistant against heat, water content, and pressure due to retort-sterilization procedures. In general, the Inagaki invention is to be used for holding liquids, including juice.

A packaging laminate is disclosed in WO 97/02140 (owned by Tetra), in which a paper or EVOH substrate has an outer coating and an inner coating that are heat resistant and have “good” vapor barrier properties. In general, these coatings are made of PP, PE, or polyester. An additional barrier layer is included between the inner coating and the substrate layer, which is made of Aluminum, silica, EVOH, PP, AlOₓ, or polyester. The laminate is useful with aseptic food packaging, in which a tube constructed of the laminate is filled at 80-90° C., or in conjunction with a “hotfill” procedure at 75-90° C., or used in an autoclave at 250° F.

A method of sterilizing containers made of a fiber material is disclosed in WO 98/16431 (owned by Tetra), in which the containers are placed in an autoclave at a predetermined temperature and pressure, for a predetermined time period. The advantage of this invention is to reduce the cycle time needed for autoclaving.

A transparent multilayer structure is disclosed in WO 98/32601 (owned by Tetra), in which an exterior film layer is made of HDPE, PP, PEN, PET, or PA, an interior film layer is made of LLDPE, PE, PP, ethylene vinyl acetate, or EVOH, and a middle layer is made of metal oxide, such as SiOₓ.

It would be an improvement to manufacture a retortable can that had no metal content whatsoever, and also to improve some of the seals made during construction of the can, perhaps without use of metal layers or metal stand-alone members. It would also be an improvement to manufacture a retortable can that uses paper or paperboard as a main structural member, either in a spiral or convolute configuration or in a side seal longitudinal configuration.

### SUMMARY OF THE INVENTION

Accordingly, it is an advantage of the present invention to provide a retortable can that is based on a paper substrate as its main structural strength layer, but also which includes other protective or shielding layers that are applied to the structural layer using an adhesive to form tie layers therebetween.

It is another advantage of the present invention to provide a retortable can that has a paper or paperboard layer for mechanical strength, an outer shielding layer that is highly heat and moisture resistant, and a protective layer that acts as a barrier to moisture, oxygen, and flavor, which is placed between the paperboard middle layer and the inner shielding layer.

It is a further advantage of the present invention to provide a retortable can made of a paperboard substrate with barrier and shielding layers that can withstand steam sterilization, and which can be manufactured in various shapes and in a variety of configurations, such as a spiral or convolute wrap, a cylindrical wall with side seal, a molded and formed container, and in a wraparound can configuration.

It is yet another advantage of the present invention to provide a retortable can that is constructed of two laminates, perhaps in a spiral or convolute configuration, in which the two laminates each have an outer paper or paperboard layer that, as the can is being constructed, are glued together by an adhesive to form a middle substrate, and in which the can has outer shielding layers and at least one barrier layer.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a retortable container is provided, which comprises: a laminated material forming a substantially hollow cylinder, a first substantially circular end member, and a second substantially circular end member; the first end member being attached to the cylinder in a manner so as to make a liquid-tight seal at first locations of attachment; and the second end member being attached to the cylinder in a manner so as to make a liquid-tight seal at second locations of attachment; wherein the laminated material comprises: (a) a first layer substantially comprising a first shielding material that is resistant to heat and moisture; (b) a second layer substantially comprising a paper material; (c) a third layer substantially comprising a first barrier material that reduces a rate of transmission of oxygen, moisture, and flavor; (d) a fourth layer substantially comprising a second shielding material that is resistant to heat and moisture; and (e) an adhesive material that substantially holds the first, second, third, and fourth layers in place with respect to one another.

In accordance with another aspect of the present invention, a laminate material usable as a structural member of a retortable container is provided, in which the laminate material comprises: (a) a first layer substantially comprising a first shielding material that is sufficiently resistant to heat and moisture to withstand direct contact with steam and retort conditions of 121° C. for 60 minutes at 15 PSI pressure; (b) a second layer substantially comprising a paper material, that is sufficiently resistant to heat to withstand 121° C. for 60 minutes at 15 PSI pressure; (c) a third layer substantially comprising a first barrier material that reduces a rate of transmission of oxygen, moisture, and flavor, and that is sufficiently resistant to heat to withstand 121° C. for 60 minutes at 15 PSI pressure; and (d) a fourth layer substantially comprising a second shielding material that is sufficiently resistant to heat and moisture to withstand retort conditions of 121° C. for 60 minutes at 15 PSI pressure, and is compatible with direct food contact.

In accordance with yet another aspect of the present invention, a method for forming a retortable container is provided, in which the method comprises the steps of: (1) providing a web of laminated material, the laminated material having multiple layers of materials of different properties, in order from a first surface toward a second surface: (a) a first layer substantially comprising a first shielding material that is resistant to heat and moisture; (b) a second layer substantially comprising a first barrier material that reduces a rate of transmission of oxygen, moisture, and flavor; (c) a third layer substantially comprising a paper material; and (d) a fourth layer substantially comprising a second shielding material that is resistant to heat and moisture; (2) moving the web of laminated material through a skiving station to form longitudinal edges in the web that are shaped for being more readily affixed; (3) moving the web of laminated material through a continuous tube forming station which wraps the web into a shape of a substantially hollow cylinder and applies an adhesive to hold the web in its substantially hollow cylindrical shape; (4) cutting the web of laminated material into a plurality of hollow cylinders of a predetermined length, each of the hollow cylinders having a first open end and a second open; (5) attaching a bottom lid to the hollow cylinders at the first open end; (6) filling the hollow cylinders with a product through the second open end; and (7) attaching a top lid to the hollow cylinders at the second open end.

In accordance with another aspect of the present invention, a laminate material usable as a structural member of a retortable container is provided, in which the laminate material comprises: (a) a first layer substantially comprising a first shielding material that is sufficiently resistant to heat and moisture to withstand direct contact with steam and retort conditions of 121° C. for 60 minutes at 15 PSI pressure; (b) a second layer substantially comprising a barrier material that reduces a rate of transmission of oxygen, moisture, and flavor, and that is sufficiently resistant to heat to withstand 121° C. for 60 minutes at 15 PSI pressure; (c) a third layer substantially comprising a paper material, that is sufficiently resistant to heat to withstand 121° C. for 60 minutes at 15 PSI pressure; and (d) a fourth layer substantially comprising a second shielding material that is sufficiently resistant to heat and moisture to withstand retort conditions of 121° C. for 60 minutes at 15 PSI pressure, and is compatible with direct food contact; wherein the second layer of barrier material comprises extrudable nylon that adheres directly to the second layer of paper material without a tie layer therebetween.

In accordance with yet another aspect of the present invention, a method for forming a hollow tube of laminated material used in a retortable container is provided, in which the method comprises the steps of: (1) providing a first web of laminated material, the first web of laminated material having multiple layers of materials of different properties, in order from a first surface toward a second surface: (a) a layer substantially comprising a paper material; and (b) at least one layer comprising: at least one of (i) a first shielding material that is resistant to heat and moisture, and (ii) a first barrier material that reduces a rate of transmission of oxygen, moisture, and flavor; (2) providing a second web of laminated material, the second web of laminated material having multiple layers of materials of different properties, in order from a third surface toward a fourth surface: (a) a layer substantially comprising a paper material; and (b) at least one layer comprising: at least one of (i) a second shielding material that is resistant to heat and moisture, and (ii) a second barrier material that reduces a rate of transmission of oxygen, moisture, and flavor; (3) moving the first and second webs to a forming station, and directing the first and second webs into an orientation such that the first surface of the first web is proximal to the third surface of the second web; and (4) applying an adhesive to at least one of the first surface of the first web and the third surface of the second web, and pressing the first and third surfaces together while wrapping the first web and the second web so as to form a substantially hollow tube of laminated material.

In accordance with still another aspect of the present invention, a laminate material usable as a structural member of a retortable container is provided, in which the laminate material comprises: (a) a first half-structure which comprises: (i) a first layer substantially comprising a paper material; and (ii) a second layer comprising at least one of (A) a first shielding material that is resistant to heat and moisture, and (B) a first barrier material that reduces a rate of transmission of oxygen, moisture, and flavor; (b) a second half-structure which comprises: (i) a third layer substantially comprising a paper material; and (ii) a fourth layer comprising at least one of (A) a second shielding material that is resistant to heat and moisture, and (B) a second barrier material that reduces a rate of transmission of oxygen, moisture, and flavor; and (c) a layer of adhesive material located between the first layer and the third layer, which affixes the first half-structure to the second half-structure.

In accordance with a further aspect of the present invention, a packaging laminate for a retortable packaging container is provided, in which the laminate comprises: a core layer; outer, liquid-tight coatings; and a gas barrier disposed between the core layer and one of the outer coatings; wherein the gas barrier is bonded to the core layer by a layer of a lamination or sealing agent which has a higher melting point than the maximum temperature to which the retortable packaging container is to be subjected during a heat treatment in a retort.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a perspective view from above and from the front of the major components of a paper-based retortable can, as constructed according to the principles of the present invention.

FIG. 2 is a diagrammatic view of a cross-section of the paper-based material used to create the retortable can of FIG. 1.

FIG. 3 is a perspective view of a continuous tube forming manufacturing process that constructs the cylindrical shape of the paper-based retortable can of FIG. 1.

FIG. 4 is a cross-sectional view looking down the centerline of the tube-forming mandrel of FIG. 3, while showing some of the details of the side-seam of the retortable can as it is being constructed in FIG. 3.

FIG. 5 is an end view showing the paper-based and layered material used in the present invention to form a retortable can, before being formed into a longitudinal seam (also known as a side seam or a body seam).

FIG. 6 shows the next step in the process for forming the longitudinal seam, illustrating the skived shape of the seam-forming members from the paperboard-layered material from FIG. 5.

FIG. 7 shows the next step in the process of forming a longitudinal seam, in which the protruding members illustrated in FIG. 6 have been folded back upon themselves.

FIG. 8 is the next step in the process for forming a longitudinal seam, in which the folded-back protruding members are joined together with a sealant compound, thereby forming the longitudinal seam.

FIG. 9 is a cut-away view showing the details of a reinforced seam that joins a lid to a cylindrical body, using the paperboard-layered material of the present invention.

FIG. 10 is a side view in cross-section of the bottom portion of a retortable can constructed according to the principles of the present invention, and using the corner or end seam/seal of FIG. 9.

FIG. 11 is a cross-sectional view of a corner or end seam/seal having a ring shape, used for joining a lid to the cylindrical body, as constructed using the paperboard-layered material of the present invention.

FIG. 12 is a side view in cross-section of the bottom portion of a retortable can constructed according to the principles of the present invention, and using the corner or end seam/seal of FIG. 11.

FIG. 13 is a cross-sectional view of an alternative embodiment of the paperboard-layered material of the present invention, while also showing the construction of this material in a manner that is closer to the ratio of actual physical dimensions.

FIG. 14 is a cross-sectional view looking down the longitudinal axis of the cylindrical side member of the retortable can of FIG. 1 without the mandrel, and showing some of the details of the longitudinal seal in which the folded members are of an increased dimension with respect to the diameter of the cylindrical member.

FIG. 15 is a cross-section view looking down the longitudinal axis of the cylindrical side wall member of the retortable can similar to that of FIG. 1, however, in FIG. 15 the configuration of the laminated paperboard material is in the form of a spiral or in a convolute shape.

FIG. 16 is a cross-sectional view showing details of another configuration for constructing a longitudinal seam for use in the retortable can of FIG. 1.

FIG. 17 is a cross-sectional view showing details of yet another configuration for constructing a longitudinal seam for use in the retortable can of FIG. 1.

FIG. 18 is a cross-sectional view showing details of still another configuration for constructing a longitudinal seam for use in the retortable can of FIG. 1, using a reinforcing member along the inner surface.

FIG. 19 is a perspective view from the side and somewhat from one end of a retortable can constructed of the laminated material of the present invention, in which the can is constructed using a spiral or convolute configuration, as shown in FIG. 15.

FIG. 20 is a perspective view from the side and somewhat from above of a retortable can made of the laminated material of the present invention, which also includes a ring for opening the container, as constructed according to the principles of the present invention.

FIG. 21 is a side view in cross-section of two portions of the laminated material as constructed according to the present invention, after a skiving operation has been performed, thereby producing two protruding members in a first step of a procedure for forming a longitudinal seam.

FIG. 22 is a side view in cross-section of the next step in the procedure for forming a longitudinal seam, in which the two protruding members are brought closer to one another and are beginning to be bent.

FIG. 23 is a side view in cross-section of the next step in forming a longitudinal seam, in which the two protruding members are brought yet closer together and are further bent, and it is now apparent that they will become interlocked with one another.

FIG. 24 is a side view in cross-section showing a further step in the operation for producing an interlocked side seam, in which the two protruding members are further bent and more clearly interlocked.

FIG. 25 is a side view in cross-section illustrating the final result, which is an interlocked side seam after the interlocking protruding members are brought together and sealed in place with adhesive.

FIG. 26 is a flow chart illustrating some of the important operations for manufacturing a retortable can, as constructed according to the principles of the present invention.

FIG. 27 is a diagrammatic view of a cross-section of an alternative embodiment for the paper-based material used to create the retortable can of FIG. 1.

FIG. 28 is a diagrammatic view of a cross-section of yet another alternative embodiment for the paper-based material used to create the retortable can of FIG. 1.

FIG. 29 is a side view in partial cross-section, and a partially exploded view, of a spiral retortable container tube constructed according to the principles of the present invention, in which two different “half-structures” are joined together to form the side walls of the container.

FIG. 30 is an end view in cross-section of the spiral retortable container tube of FIG. 29, depicting the two “half-structures” after they are assembled.

FIG. 31 is a side view in cross-section of a body seam according to the principles of the present invention, in which the two portions of laminated paperboard material are skived, and have protruding fingers that interlock while the entire seam is protected by the shielding layers.

FIG. 32 is a side view in cross-section of a corner joint or corner seal, constructed according to the principles of the present invention, in which the shielding layers are used to protect the inner structure throughout the joint/seal.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

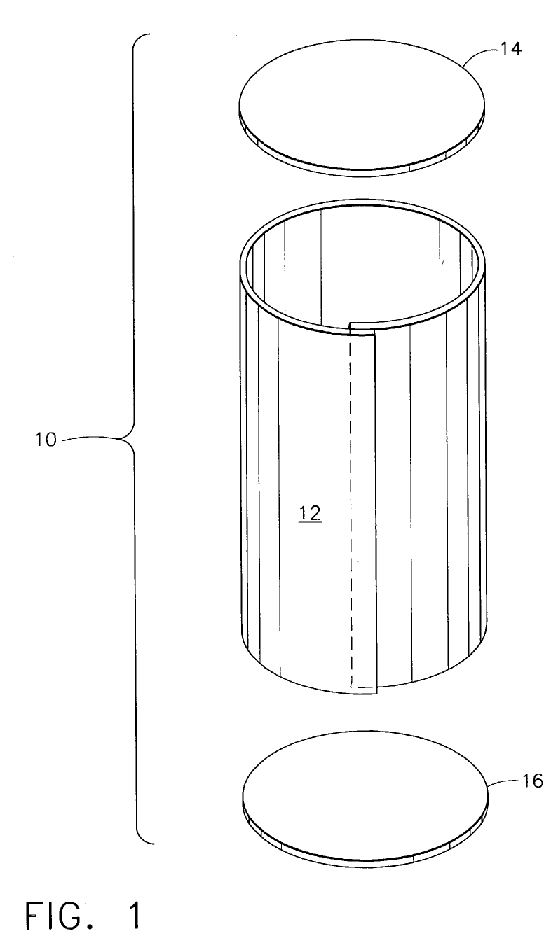

Referring now to the drawings, FIG. 1 illustrates in an exploded view the main structural members of a retortable container (typically referred to herein as a “can”), generally designated by the reference numeral 10. The cylindrical side wall 12 is to be joined by a top or first end 14, and a bottom or second end 16. The structure of this cylindrical side wall 12 is depicted in relatively simplistic form, and does not show any of the details of a longitudinal seam that would be required to make the can watertight.

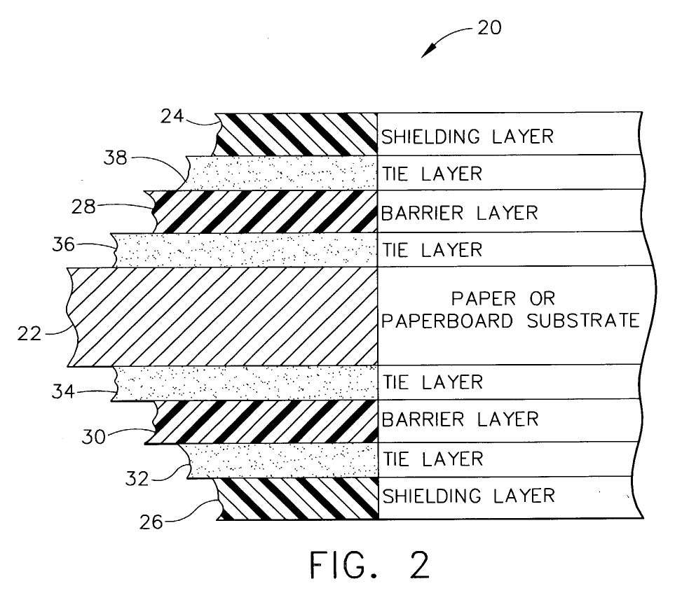

FIG. 2 shows some of the details in a diagrammatic form of the various layers that make up the material used to create the retortable can illustrated in FIG. 1. The overall structure is generally designated by the reference numeral 20, which comprises a middle paperboard substrate 22, two outer shielding layers 24 and 26, and two intermediate barrier layers 28 and 30. Each of the adjoining layers is to be affixed to the next adjoining layer by a tie layer, which is a type of adhesive compound. In FIG. 2, the tie layers are designed at the reference numerals 32, 34, 36, and 38. It will be understood that the chemical compound that makes up the tie layers 32-38 could be the same for each of the individual tie layers, or alternatively, some of the tie layers could be of one compound while other tie layers are of a second compound, depending upon the adhesive-contacting properties of the actual shielding, barrier, or paperboard layers.

The properties of the various layers depicted in FIG. 2 will now be discussed in a certain detail. For example, at least one of the shielding layers 24 and 26 should be constructed to withstand steam sterilization, and should exhibit a relatively high heat resistance of at least 250° F. (about 121° C.). In addition, at least one of the shielding layers 24 and 26 would preferably be water and grease resistant, and approved for food contact. Moreover, if the shielding layer 26 is to be the inner layer (as illustrated in FIG. 2) of the can, then it would preferably exhibit food compatibility such that it would not interact with the food product after the product is placed into the can, for potentially long-term storage. The outer shielding layer (e.g., layer 24) may not necessarily need complete food compatibility, but would still need to be steam and heat resistant if it were to be sterilized in any process that would not isolate the outer shielding layer from the steam or heat itself. Of course, during a retort procedure, with the food product already in the can, the outer layer 24 must endure the retort conditions, including direct contact with steam.

The tie layers should provide good bonding between the paperboard substrate and the barrier layer for the tie layers 34 and 36, and should provide good bonding between the barrier layer and the shielding layer for the tie layers 32 and 38. The tie layers will also need to have a relatively high heat resistance (of at least 250° F.), and potentially will need to have the ability to withstand steam sterilization and otherwise be approved for food packaging compatibility. Of course, the tie layers will normally not come into direct contact with the food products, because the shielding layer would normally be the outermost layer that would be in contact with the food products. However, at the point of cutting the laminate material 20, one or more of the tie layers could become exposed and thus potentially come into contact at a very small area with a food product.

The barrier layers 28 and 30 are mainly required to greatly inhibit transmission of moisture, oxygen, and flavor through the laminate material 20. In addition, it would be preferred that the barrier layers can withstand steam sterilization and exhibit a relatively high heat resistance (at least 250° F.). For the same reasons as discussed with regard to the tie layers above, the barrier layers would preferably be approved for food contact and otherwise for food compatibility purposes.

The paperboard substrate 22 provides the main mechanical strength, and also is referred to herein as a “structural layer.” Paperboard layer 22 will preferably exhibit certain important properties, such as: high ring crush value, high puncture resistance, high tear resistance, high stiffness, high tensile strength, high bursting strength, high crimping properties, relatively low thickness, relatively low weight, relatively low extractability, and food compatibility.

The overall laminated structure of FIG. 2 can be constructed of relatively low cost materials while obtaining the properties described above. For each of the structural layers, processing compatibility and structural integrity are important for ease of manufacturing. Also of consequence is product protection capability, and the ability for a desirable appearance after the can has been manufactured and filled with the food product. For most applications, the retortable can of the present invention should be able to withstand 250° F. (about 121° C.) temperature for a minimum time period of sixty minutes and a minimum pressure of fifteen PSI. It would be preferred if the can's moisture resistance specification is less than 0.1 grams per one hundred square inches per day, and if the OTR (oxygen transmission rate) specification would be less than 0.1 cubic centimeters per one hundred square inches per day. Other desirable characteristics would be a physical strength of greater than one hundred fifty pounds TBC, and a product protection time interval of greater than six (6) months.

It should be noted that the above-described structure of FIG. 2 is substantially symmetrical with respect to the types of layers involved. There is a barrier layer (i.e., layers 28 and 30) on each side of the paper substrate 22, and of course some type of shielding layer (i.e., layers 24 and 26) is also provided on each side of the paper substrate. Both barrier layers may not be necessary in many designs for retortable cans; however, it may be desirable to use a symmetrical laminate structure (such as laminate material 20) to construct cans in a high-speed automatic process manufacturing line, so that either side of the laminate 20 can be skived or folded when creating corners or side seams. It really depends upon the precise manufacturing system and the shapes of the corners and seams.

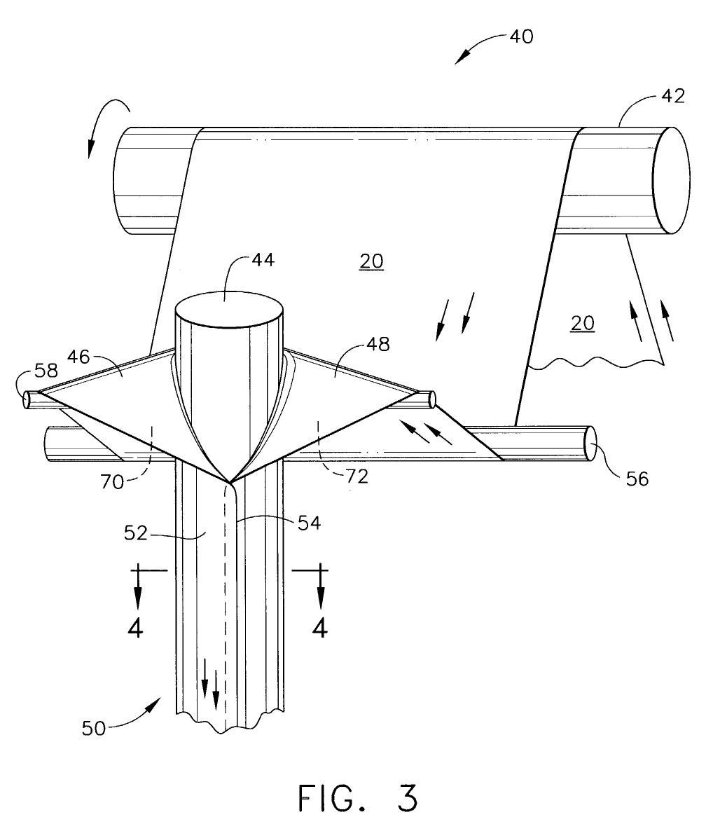

Once the various layers are laminated together into the laminate material 20 (as illustrated in FIG. 2), cylindrical retortable cans can easily be made in a continuous operation, including a continuous tube-forming operation that is partially illustrated in FIG. 3. In FIG. 3, a tube-forming station, generally designated by the reference numeral 40, is illustrated, which takes a web of the laminate material and forms it around a mandrel to create a cylindrical tube, after which a longitudinal seam (also known as a “body seam” or a “side seam”) is formed.

The web of laminate material 20 is first directed over a stationary tension roller 42, and then re-directed toward an adjustable tension roller 56. By the time the web of laminate material 20 has reached this stage, it has already been slit to the proper width (to form the correct diameter can), and in some processes has already been skived along its outer edges, which is useful for quickly forming a durable longitudinal seam.

The laminate web is now directed over a forming roller 58, and then the web is directed over a V-shaped collar that is not visible on FIG. 3, but is formed of members that are at locations using dashed lead-lines designated by the reference numerals 70 and 72. The web of laminate material covers the collar 70, 72 at this point, at the areas designated by the reference numerals 46 and 48. The web of laminate material is also formed about a mandrel 44, which creates the cylindrical shape that will become the retortable can's final shape.

The web of laminate material is now directed downward (when viewed in FIG. 3), and has now become a hollow cylinder as seen at the reference numeral 52. The laminate material overlaps itself along a longitudinal edge, as seen at reference numeral 54. The cylindrical material continues downward at the reference numeral 50, and will become sealed along this longitudinal overlay, to create the (body seam, side seam) longitudinal seam. This is depicted in greater detail in FIG. 4.

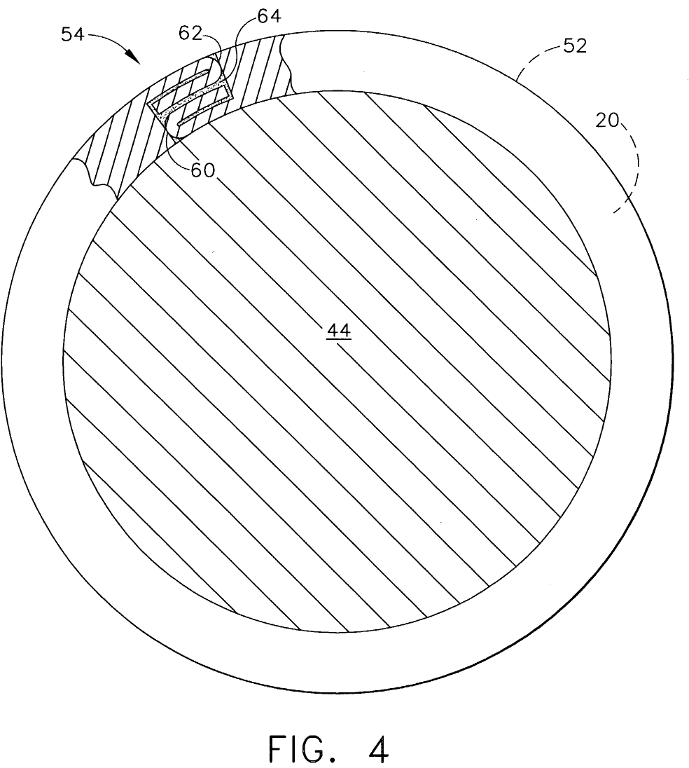

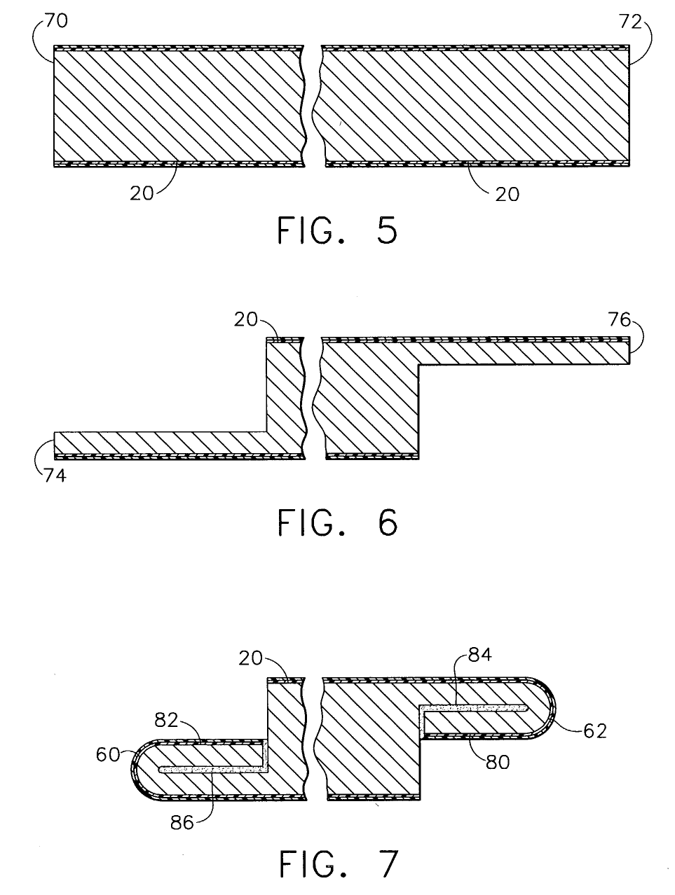

FIG. 4 shows the cross-sectional view of the cylindrical laminated material 20 as it is being directed down the tube-forming mandrel 44. The side edges of the laminated web have been formed into protruding and folded fingers that overlap one another, as illustrated at the reference numerals 60 and 62 in FIG. 4. These overlapping and folded protrusions are glued or otherwise affixed in place, preferably by an adhesive compound or sealant illustrated at 64. Further details of the manufacturing and forming of these protrusions 60 and 62 are provided in FIGS. 5-8.

It will be understood that the folded fingers design illustrated in FIG. 4 can be used with both a longitudinal or side seam, and with a spiral-wrapped (or convolute-wrapped) retortable can design. This statement is also true for many of the other seam designs that are discussed below and illustrated in the drawings.

It will be further understood that references herein to a spiral container design or a convolute container design are often interchangeable. A spiral or tube shape is usually in reference to a “round” design, such as a hollow cylinder for the overall shape of the container. A convolute container may refer to a non-round shape, such as an oval, or a rectangular shape (typically with rounded corners) for the container when viewed from above the can.

Referring now to FIG. 5, the laminated material 20 is illustrated from an end view such that it has a left side edge 70 and a right side edge 72. This would be the appearance of the laminated material as it is being formed into a web that will later become a cylinder. These side edges 70 and 72 are skived in an edge skiving operation (see step 510 on FIG. 26), after which two protrusions 74 and 76 remain along the edges of the laminate web 20, as illustrated in FIG. 6. After these protrusions 74 and 76 are formed, they are folded back upon themselves as illustrated in FIG. 7 (see step 518 on FIG. 26). The protrusion 74 now becomes the folded member 82, which has a 180° turn at 60, and a sealant or adhesive 86 is used to hold the two portions of the protrusion 82 in place. In a similar manner, the protrusion 76 is folded back upon itself, and becomes the member 80, which undergoes a 180° turn at 62, and is adhered to itself by a sealant or adhesive 84.

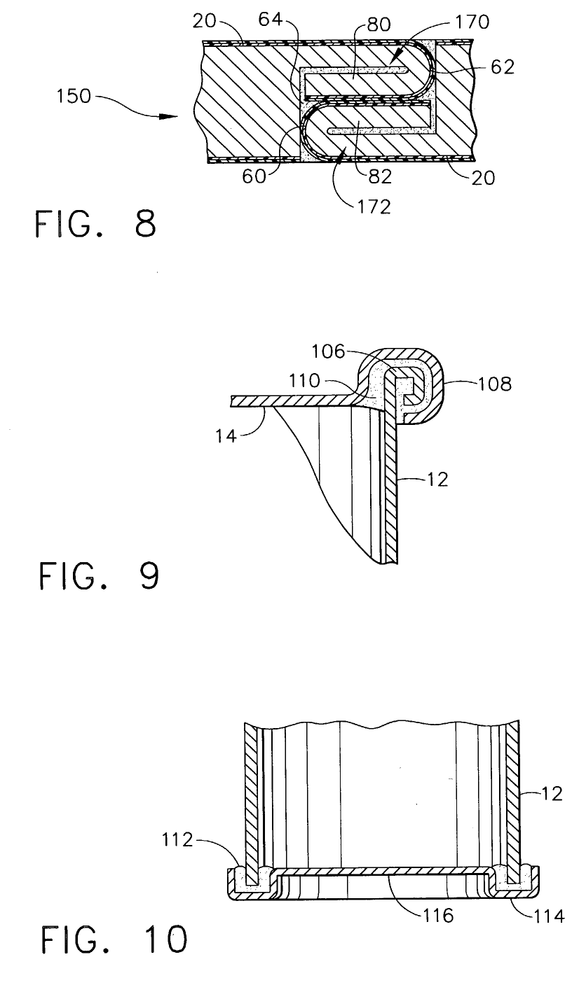

Once the fold-over members have been created, the web of laminate material 20 is formed around the mandrel 44 to form a hollow cylinder, and the members 80 and 82 come into relatively close contact with one another, as illustrated in FIG. 8. A sealant or adhesive material is applied between these members 80 and 82, as depicted at 64 on FIG. 8. The edge sealant is applied at a step 520 on FIG. 26, and the cylindrical tube is formed at a step 522.

The result is a longitudinal seal, generally depicted by the reference numeral 150. If the upper portion of FIG. 8 is the outer surface of the retortable can, then a member 170 forms this outer surface along the longitudinal seal, and a member 172 forms the inner surface of the longitudinal seal. Other configurations for making longitudinal seals are discussed below, and other configurations for creating a cylindrical laminated material surface are described below.

Referring now to FIG. 9, a relatively square corner seal is illustrated and is used to hold the top of the can 14 to the cylindrical surface of the can 12. This corner seal would typically not be made until after the can has been filled with a food product or other type of liquid to be stored therewithin. In FIG. 9, the end of the cylindrical tube 12 is bent at right angles, as illustrated at 106, to create a reinforcing member for additional mechanical strength. The lidding material 14 is also bent at 90°, as depicted at 108, so as to surround the reinforcing member portion 106 of the side wall material 12. A sealant material is applied at 110 to provide a permanent bond between the structural members 106 and 108.

Referring now to FIG. 10, some details of the bottom portions of the can construction are illustrated. The lidding material at 116 is formed into a relatively right-angle shape, as illustrated at 114. The side wall of the can (at 12) is then placed against this corner construction 114, with a sealant material at 112 interposed therebetween to create a permanent bond. In FIG. 10, the remaining portion of the lidding material at 116 is substantially planar in shape.

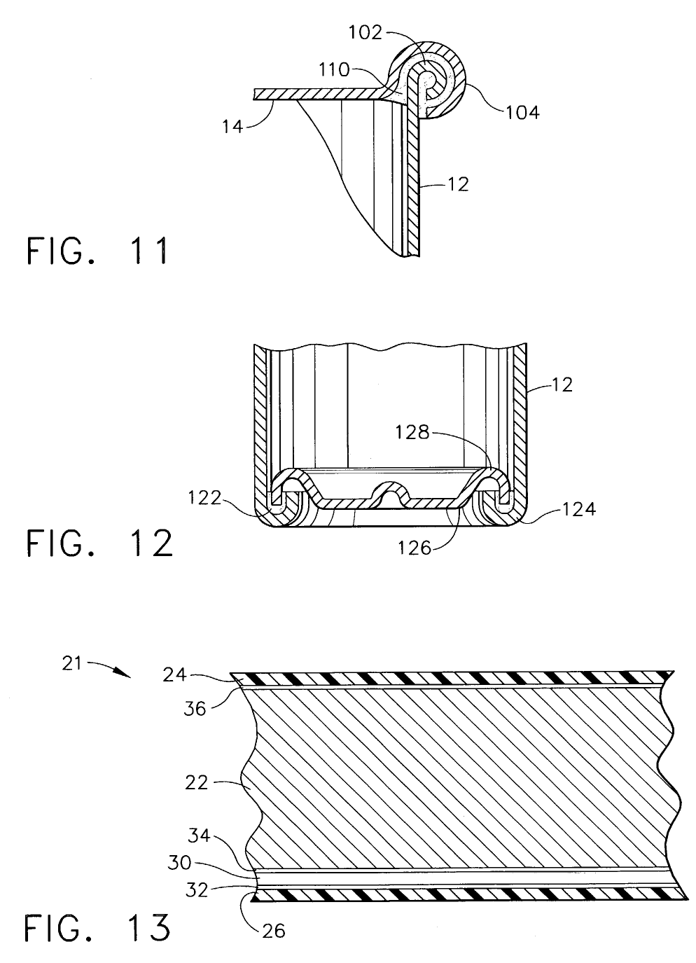

An alternative construction for the corner seal is illustrated in FIG. 11, in which the end of the cylindrical body of the can is formed in a circular or arcuate shape, as depicted at 102. The lidding material is now formed in a ring (or arcuate) shape, as illustrated at 104, to encompass the circular or ring-like shape at 102. Again, a sealant material at 110 is used to provide a permanent bond between the members 102 and 104.

FIG. 12 illustrates an alternative construction for the bottom portions of the retortable can of the present invention. The side wall material 12 is not straight throughout its run to the bottom of the can, but instead forms a half-circle near its bottom terminus, as illustrated at 124. The lidding material of the can is also formed into a half-circle, as depicted at 128, and the most protruding portion of these two half circles of material at 124 and 128 are positioned such that they come quite close to one another, and are then bonded by a sealant material 122. The remaining portion of the lidding material has an indentation in this embodiment, as seen at 126.

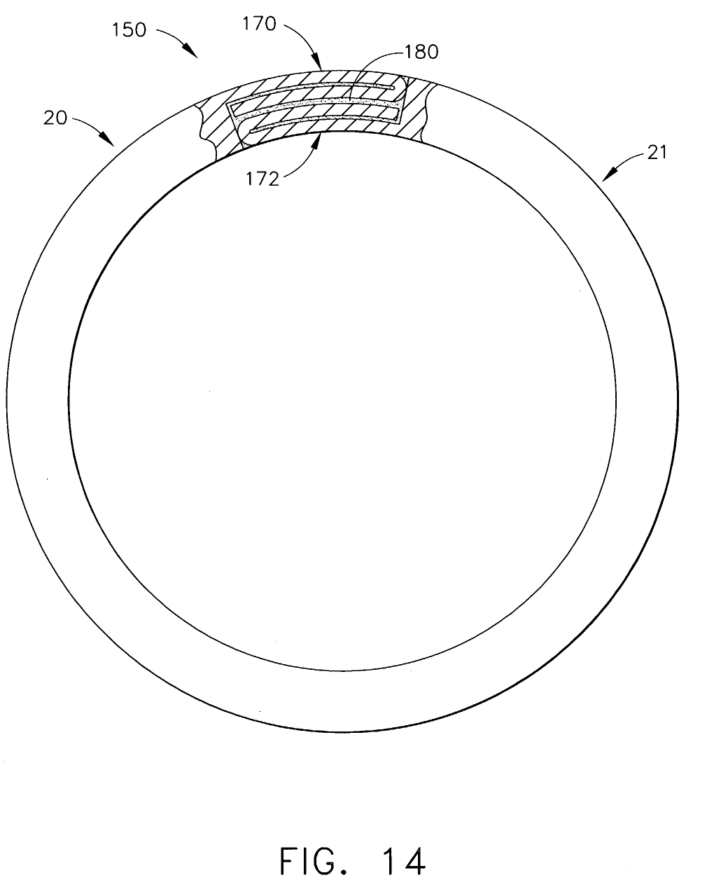

FIG. 13 is a cross-sectional view of an alternative embodiment of laminate material 21 used to make the retortable can 10, and in this figure the various layers are portrayed in a more correct appearance with regard to the ratio of actual dimensions. As can be seen in FIG. 13, the paperboard substrate 22 makes up the largest component by far, and the shielding layers and barrier layers are quite thin by comparison. Moreover, the thickness of the tie layers is minimized to the extent possible while ensuring proper bonding and structural integrity of the other laminate layers, but at the same time to minimize costs by using a minimum amount of tie layer material.

It should be noted that, in FIG. 13, there is only a single barrier layer at 30. This illustrates the possibility of deleting the “second” barrier layer as it was illustrated at 28 in FIG. 2; of course, the associated tie layer 38 could then also be deleted from the structure 20 in FIG. 2, as is illustrated in FIG. 13. If the “interior” barrier layer 30 has sufficiently great reduction of transmission properties for oxygen and moisture, etc., then perhaps only a single barrier layer is needed within the entire laminate structure 21.

It will be understood that for most (or all) purposes of the present invention, either laminate material structure (i.e., laminate 20 in FIG. 2 or laminate 21 in FIG. 13) can be used, and in effect, laminates 20 and 21 are substantially interchangeable with one another. In many of the illustrations herewith, the laminated material of the present invention will be referred to as both reference numerals 20 and 21. With regard to the written description, both laminates 20 and 21 in general will sufficiently serve the purposes and provide the important advantages of the present invention, and a reference to only the laminate 20 will, by inference, typically apply to the alternative structure laminate 21.

It will be understood that there are certain circumstances where the barrier layers and shielding layers could be combined into a single layer of material that would exhibit the necessary properties to perform the functions of both the shielding and barrier layers. This would also eliminate one of the tie layers. Furthermore, it may be possible to coat the paperboard substrate with a material that would not only provide the necessary shielding and/or barrier properties, but may also be self-adhering and therefore, eliminate the need for a tie layer at all. This aspect of the present invention will be discussed in greater detail below.

It will be further understood that the materials used for the two shielding layers 24 and 26 will often be identical, however, that need not be the case for all structures that are encompassed by the present invention. Many different materials can be used for these shielding layers, and a listing of examples of such is provided below. The same is true for the barrier layers 28 and 30 when the laminate structure 20 is used-i.e., if there are two separate barrier layers, then their materials may be identical, but that need not be the case for all structures that are encompassed by the present invention. A listing of example materials for the barrier layer(s) is also provided below.

FIG. 14 portrays one of the overlapping longitudinal seams, generally designated by the reference numeral 150. In FIG. 14, the protruding fingers or members are designated at the reference numerals 170 and 172, forming the outermost and innermost layers at the seam, respectively. Of course, these two sets of protruding fingers are bonded together by a layer of sealant or adhesive 180. In FIG. 14, the seam is larger in dimension with respect to the overall circumference of the can, as compared to the earlier examples illustrated in FIG. 4.

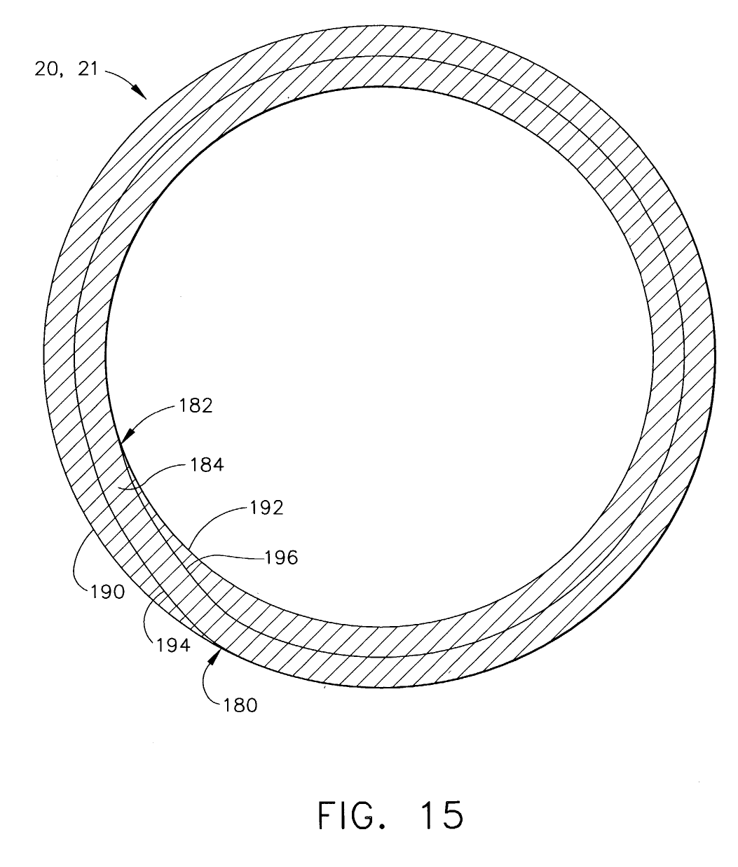

An alternative construction of the retortable can's cylindrical walls is illustrated in FIG. 15. Instead of a single laminate layer that is constructed using a longitudinal seam, FIG. 15 illustrates a convolute or spiral-shaped construction. A body joint at 180 is formed at the outermost surface where the laminated material is skived at an angle to form the outer member 190. A sealant or adhesive is applied along the contact surface (i.e., at 194) between the outermost layer of material 190 and the center layer of material 184 at this portion of the circumference of the can. A corresponding inner body joint is formed at 182, which is the innermost terminus of a skived member 192 that also is skived at an angle. A sealant or adhesive material is applied between the innermost member 192 and the center laminated layer at 184. This adhesive or sealant material is applied along the contact surface at 196.

By use of this convolute or spiral configuration, the retortable can of the present invention can be made with a non-longitudinal side seal, and will result in a can having a structure that is illustrated in FIG. 19, described below.

FIGS. 16-18 illustrate different configurations for a longitudinal seam along the side of the hollow cylindrical shape that forms the retortable can of the present invention. Referring now to FIG. 16, two different portions of the laminate material 20 are illustrated at 206 and 208. Both of these end portions have already been skived, and therefore, exhibit protrusions at 202 and 204. A sealant or adhesive material is placed along the inner surfaces of these two protrusions, essentially along the Z-shaped line at 210 on FIG. 16. This creates a longitudinal seal, generally designated overall by the reference numeral 200.

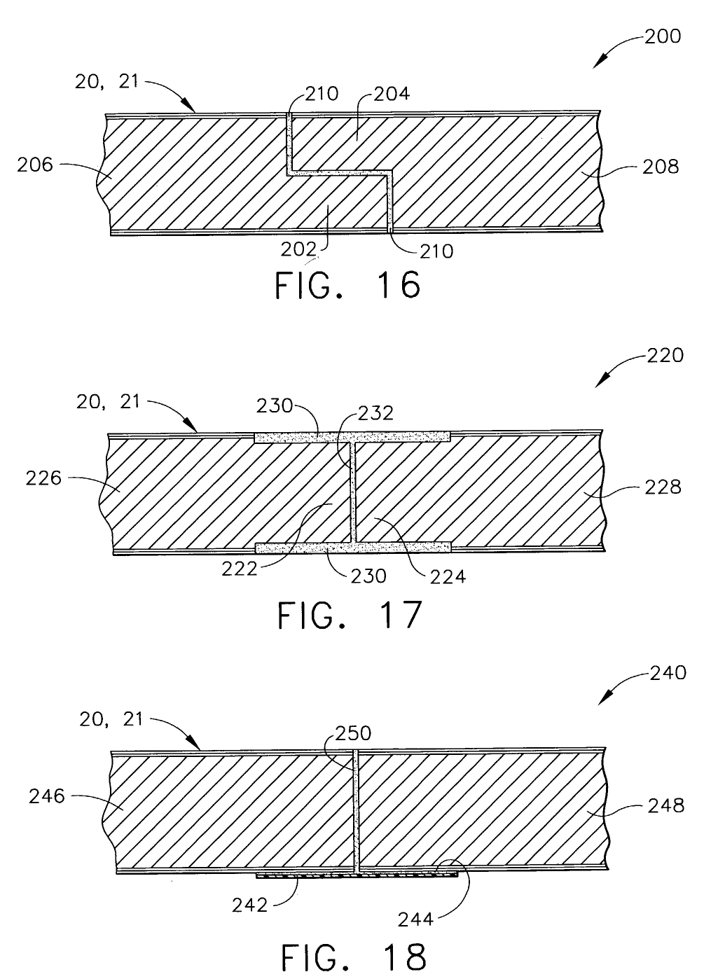

Referring now to FIG. 17, the laminate material 20 is illustrated as two portions 226 and 228, in which their end edges are brought together to form a longitudinal seal. The left-hand edge in FIG. 17 is designated at the reference numeral 222, while the right-hand edge is designated at the reference numeral 224. A small portion of the protrusions 222 and 224 is removed by a skiving operation, to form a small indentation along their outer surfaces. A sealant material is then placed into these indentations, which are illustrated on FIG. 17 at 230. A sealant material is also used to join the two edges together, as illustrated at 232. This forms a longitudinal seal, which is generally designated as an overall structure by the reference numeral 220.

If desired, in an alternative construction the sealant at the areas 230 can be replaced by two solid reinforcing members having the necessary chemical and physical properties. Of course, such reinforcing members 230 would need to have resistance to relatively high heat (e.g., for a steam sterilization step) and chemical resistance to food products. Moreover, such reinforcing members would have to have the necessary adhesive characteristics so that they would be adherable to the sealant used at 232.

Referring now to FIG. 18, the laminated material 20 is illustrated as having two portions at 246 and 248. These represent the edges of the laminate after it has been formed into a cylinder. These two edges are brought together and affixed to one another using a sealant or an adhesive at 250. In addition, a reinforcing member 242 is placed along the inner surface 244 of the members 246 and 248. This reinforcing member can be made of any desirable material, but obviously would need to have proper qualities so that it would adhere to the adhesive or sealant 250. Moreover, if it is to be used in a retortable can, the reinforcing member 242 must also have the necessary physical and chemical properties to withstand high temperature and to be compatible with food products. By use of this configuration, the longitudinal seam is formed at 250 along with the reinforcing member 242, and the overall structure is generally designated by the reference numeral 240.

It will be understood that the sealant materials or adhesive materials that are described in the various embodiments herein must also exhibit the necessary physical and chemical properties. In other words, the sealant (and adhesive) material itself must be able to withstand the high temperatures and steam or moisture-resistant properties so that it can be used in a sterilization process. Moreover, it must have chemical properties such that it would not react with or leach out into any type of food product that it may come into contact with in the interior surfaces of the retortable can.

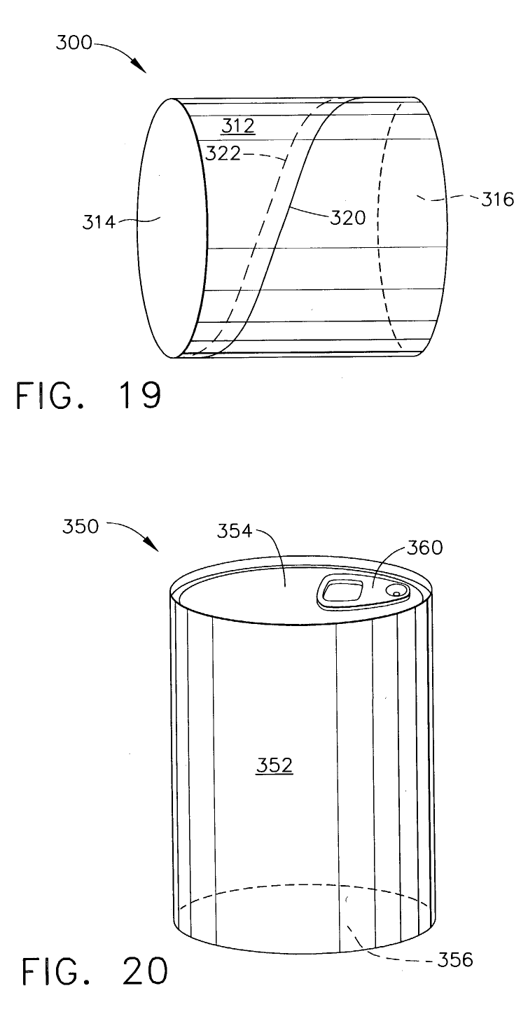

The sealant material could comprise a thermoset adhesive, but would be required to withstand retort conditions of sterilization, for example. The top and bottom end members 14 and 16, respectively, could be made of the same laminate material 20 that is primarily paperboard, if desired. Of course, the top member 14 could also be a standard aluminum flip-top lid that is used in conventional pet food cans, or could be a standard aluminum flip-top lid used to contain carbonated beverages, or other types of juices. Such a design is illustrated in FIG. 20, described below.

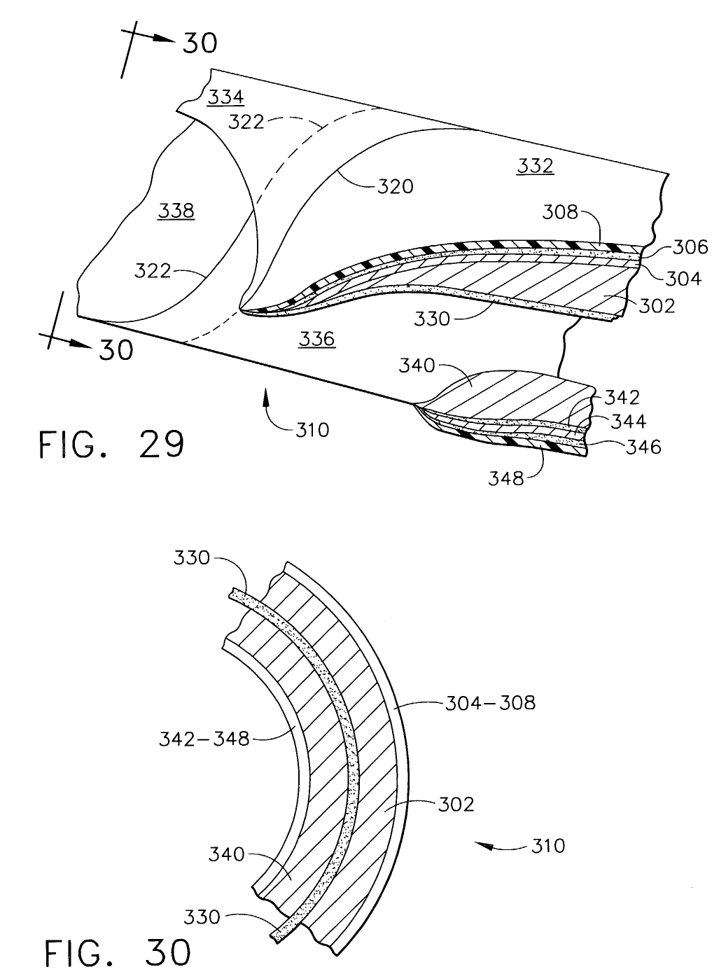

As noted above, the laminated paperboard material 20 can be converted to a cylinder either by a spiral winding or by a longitudinal edge sealing procedure. While the edge sealed embodiment is illustrated in FIG. 1, the spiral-wound cylinder embodiment is illustrated in FIG. 19. Referring now to FIG. 19, the retortable can is generally designated by the reference numeral 300. Its cylindrical sidewall structure is designated at the reference numeral 312, and is sealed in a spiral pattern along the lines 320 and 322. One of these spiral curves 320, 322 represents the outer seal (i.e., which would be equivalent to the body joint 180 on FIG. 15) while the other spiral such as 322 would represent the inner body joint (e.g., equivalent to the body joint 182 on FIG. 15). These two spiral seals may be constructed of two “half-structures” that each consist of a different laminated material; this type of construction is described below in greater detail, in reference to FIGS. 29 and 30.

The top of the spiral-wound can 300 is illustrated at 314, while the bottom cannot be seen in this view, but is designated in dashed lines at 316. The actual corner seals to adhere the top and bottom end surfaces to the cylindrical hollow laminated surface can be made up of the types of corners illustrated in FIGS. 9-12, as discussed above.

Referring now to FIG. 20, a retortable can generally designated by the reference numeral 350 is illustrated as having a cylindrical sidewall at 352, a top 354, and a bottom that is not visible in this view, but is generally designated by the reference numeral 356 in dashed lines. This retortable can could use the materials of the present invention for the cylindrical wall 352 and the bottom lid or end 356. However, a metallic material might be best for the top lid 354, and a metallic ring at 360 could then be provided to open the package. This could be the standard aluminum flip-top lid that is commonly used for pet food cans and for other types of foods and beverages.

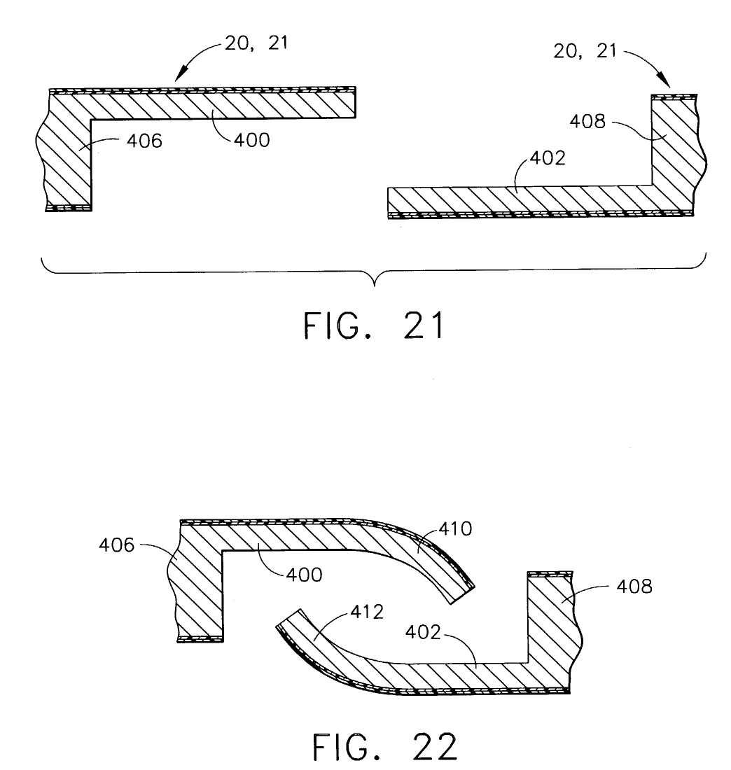

FIGS. 21-25 illustrate a process by which a longitudinal seam is constructed in a similar manner to the process and structure illustrated in FIGS. 5-8, however, in this instance the protruding fingers become interlocked. In FIG. 21, two portions of laminated paperboard material 20 are illustrated at 406 and 408. Both of these “end” portions have already been skived, and a protrusion 400 has been made in the end portion 406, while a protrusion 402 has been made in the end portion 408.

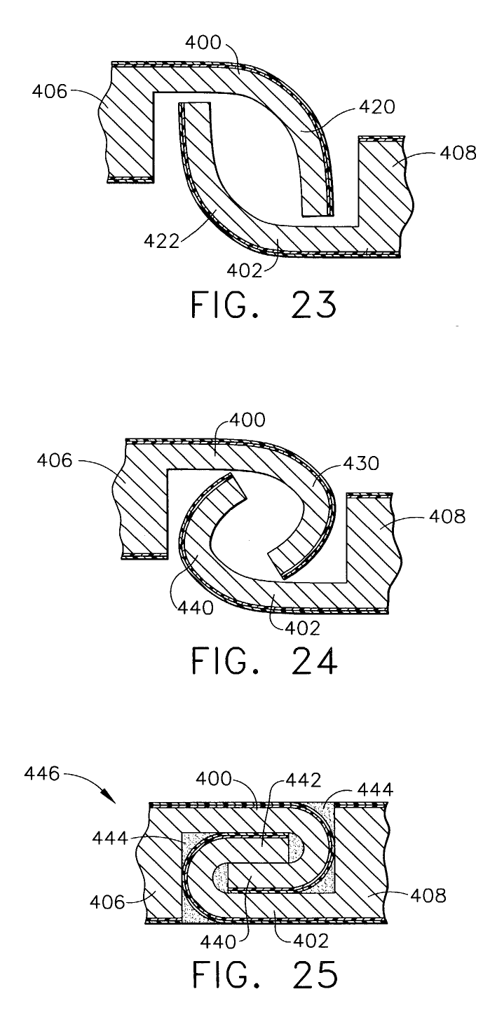

In FIG. 22, the next process step is being performed, in which the tip portion of the protrusion 400 has started to be bent, as illustrated at 410. Similarly, the tip portion of protrusion 402 has begun to be bent at 412. Additionally, the two end portions 406 and 408 have been brought closer to one another. In FIG. 23, the next step of the process is illustrated by which the tip 420 of the protrusion 400 has been bent further, and now has exhibited a 90° angle. Similarly, the tip portion 422 of protrusion 402 has been bent to the same degree. In FIG. 24, the following process step is illustrated, by which the two protrusions 400 and 402 have been made into a U-shape, at their tip portions 430 and 440, respectively.

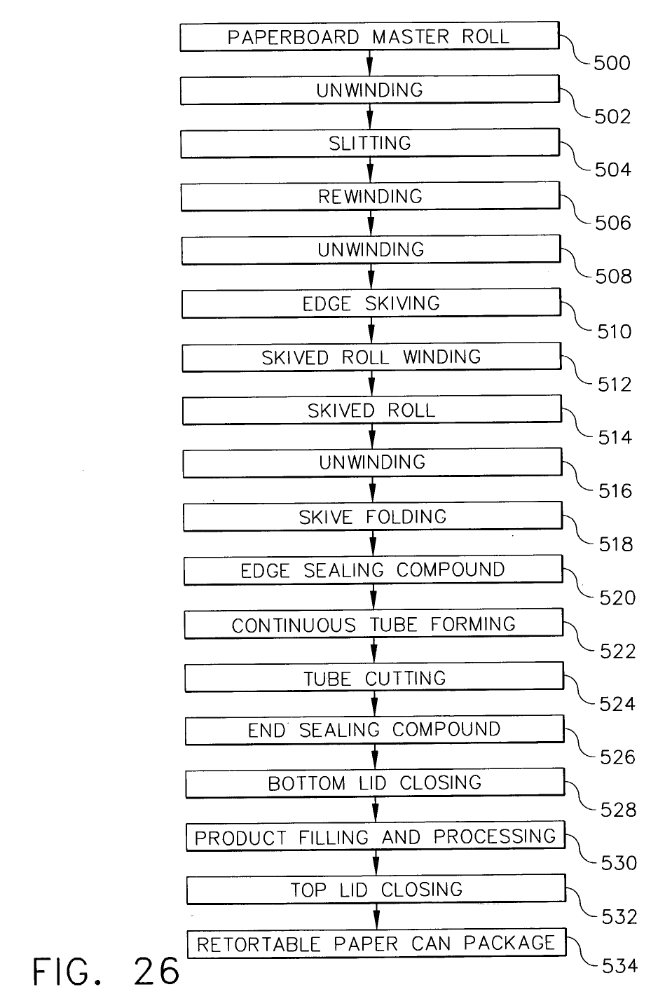

FIG. 25 illustrates the final form of the longitudinal seal, which is generally designated as an overall structure by the reference numeral 446. The two protrusions 400 and 402 have both been completely bent into a U-shape, as illustrated at their tip portions 440 and 442. A sealant or adhesive material has been applied at 444 to maintain the positioning of the interlocking protrusions, and to make sure that they are affixed well to one another. Similar to the seals described above, the adhesive or sealant material 444 will need to have certain physical and chemical properties, and for use in a retortable can the sealant would need to have a relatively high temperature capability, and would need to be compatible with foods and/or beverages.

FIG. 26 is a flow chart that illustrates some of the important steps in a manufacturing process to create retortable cans that are based on a laminated paperboard material. Beginning with a paperboard master roll at a step 500, the paperboard material is first directed through an unwinding operation at a step 502. At this time, the paperboard material or web is slit to its proper width (i.e., to create a can of the proper diameter) at a slitting step 504. After that has occurred, the web of material is sent through a rewinding step 506, where it once again becomes a roll. At this point, the “siit roll” could be stored for a long time duration, if desired. This “storing” procedure can decouple the winding step 506 from the next step in the manufacturing process, so that the slit rolls can be stored until needed, perhaps much later.

The next step in the manufacturing operation is an unwinding step 508, after which the web of material is directed through an edge skiving step 510. It is at this step that, for example, the protrusions 74 and 76 as illustrated in FIG. 6, are formed. After being skived, the web of material is directed to a skived roll winding step 512. At this point, the skived roll can be stored (at a step 514), if desired. Otherwise, the skived roll storing step 514 can be eliminated, and the skived roll can be immediately directed to a rewinding step 516. This forms a web of material that is next directed to a skive folding step 518 which, for example, forms the U-shaped fingers or protrusions 80 and 82 as illustrated in FIG. 7. After this skive folding step 518, the web of material has a sealing compound applied to its edges at a step 520.

Once the sealing compound has been applied to the web, it is important that the paperboard web be more or less immediately formed into a tube, by use of a structure and method as illustrated in FIG. 3, for example. This occurs at a continuous tube-forming step 522 on the flow chart of FIG. 26.

Once the tube has been formed with either a side seal or a spiral-configuration seal, the next step in the process is to cut the tube into individual can sizes at a tube cutting step 524. The next step in the process at 526 is to apply sealing compound to the ends. After that occurs, a bottom lid closing step 528 is used to attach the bottom end, such as the bottom end portion 16 on FIG. 1. The types of corner seals that could be used for forming these seals include those illustrated on FIGS. 9-12, as described above.

The next step in the processing of the retortable can is to fill the can with a product at a step 530. Once that has occurred, a top lid closing step 532 would likely need to be performed immediately, both to prevent germs or other undesirable compounds from reaching into the contents, and also to prevent any spillage. The top lid could be a laminated paperboard member such as the top 14 illustrated in FIG. 1. For certain products, it may be desirable to use a metal top with a ring opening mechanism. The top corners could be such as those illustrated on FIGS. 9-12, as described above. Once the top lid closing step 532 has been performed, the final step is to distribute the retortable cans with their intact contents, at a final step 534.

The materials used to create the laminated paperboard can be critical with regard to its retortable characteristics. The material of the paperboard layer itself may not be entirely critical, because it will generally be protected from physical contact with the food products. Of course, it still must be able to withstand the high temperatures of sterilization or other germ-killing procedures. In general, the paperboard could be unbleached Kraft paper, or SBS (solid bleached sulfate). The paperboard could be single or multi-ply, and it could be clay-coated, if desired.

The paperboard substrate would typically be coated on both sides with various layers, typically some type of plastic material or polymer to obtain suitable performance characteristics. As noted above, the structural layers and barrier layers would typically be affixed to one another with adhesive tie-layers, all of which would need to withstand retort temperatures, such that the complete structure is able to withstand the retort pressure and filling line pressure without leakage or mechanical damage.

The coated paperboard laminate could be symmetrical in its construction, if desired, or its inner surface could be somewhat different from its outer surface. Of course, its inner surface would be the one that normally comes into contact with the food products. Naturally, both the inner and outer surfaces would have to be able to withstand the retort temperatures and be able to withstand direct contact with steam when used in such a sterilization procedure. The inner layers must certainly be capable of withstanding moisture while also providing an oxygen barrier.

Many different types of structural layers could be used as a moisture and oxygen barrier. For example, amorphous nylon, moisture-resistant nylon blends, thermoplastic polyester (PET), crystallized polyester (CPET), polyethylene naphthalate (PEN), a PET-PEN blend, moisture resistant polyester, polypropylene (PP), or high crystallinity polypropylene (HCPP) could be used that have the ability to withstand moisture and retort temperatures.

The innermost layers could also be mainly composed of polymer layers that would meet the moisture, oxygen, and flavor barrier properties as well as the temperature and pressure requirements. Examples of such materials are PET-LCP alloys, or LCP (thermotropic liquid crystal polymer), or EVOH (ethylene vinyl alcohol copolymer) co-extruded coating, or EVOH-amorphous nylon blend as co-extruded coatings with suitable intervening adhesive tie-layers. An example of an LCP is VECTRA™ A-950 made by Allied-Signal.

As an alternative, the oxygen, flavor, and moisture barrier properties could be provided with materials such as silicon oxide (SiOₓ), alumina (AlₓO_{y}), or aluminum (Al) coated on one of the intervening polymers, or even a layer of aluminum foil.

For some applications, the layered material used in the present invention does not necessarily need both a shielding layer and a barrier layer on both sides of the paperboard middle (or core) layer. For example, if the barrier layer on the inner half of the layered material is sufficiently “strong” to prevent significant transmission of oxygen, moisture, and flavor, then a second barrier layer would not really be required on the outer half of the layered material.

Some further example structures encompassed by the present invention are listed below, in which the first (left-most) material listed represents the outermost layer, which typically would be covered with a label. The final (right-most) material listed above represents the innermost layer that would be in contact with the food product. The term “TL” represents a tie layer of adhesive or sealant material.

| | | |
|---|---|---|
| HCPP/TL | paperboard | TL/HCPP/TL/EVOH/TL/PET |
| HCPP/TL | paperboard | TL/EVOH-amorphous |
| | | nylon blend/nylon-6 |
| nylon-6/TL/HCPP | paperboard | TL/HCPP/TL/EVOH/TL/PET |
| nylon-PP moisture | paperboard | amorphous nylon/ |
| resistant blend | | EVOH/TL/PET |
| moisture-resistant | paperboard | TL/LCP/TL/HCPP |
| polyester/TL | | |
| HCPP/TL | paperboard | TL/PET-LCP alloy/TL/CPET |
| CPET/TL | paperboard | TL/LCP/TL/CPET |
| PET-PEN blend/TL | paperboard | LCP/TL/amorphous nylon |
| PET/TL/SiOₓ/PET | paperboard | TL/nylon-6,6/TL/PP |
| moisture resistant PET/TL | paperboard | TL/Aluminum foil |
| PET/TL/AlₓO_{y}/PET | paperboard | TL/nylon-6,6/TL/PP |
| CPET/TL | paperboard | TL/SiOₓ/TL/CPET |
| PET/TL | paperboard | TL/PET metalized |
| | | with Al/TL/PET |
| PEN/TL/HCPP/TL | paperboard | EVOH/TL/HCPP |
| nylon-6,6/TL/HCPP | paperboard | TL/EVOH/TL/PP |

The layers of materials could be coated onto the paperboard substrate by commonly-known processing techniques, such as co-extrusion coating, extrusion lamination, or co-extrusion lamination, etc. The SiOₓ or AlₓO_{y} or aluminum could be deposited on a polymer layer or film, or on a PET-coated paperboard with a vapor deposition technique, also commonly known in the industry.

It will be understood that the exact materials used in constructing the laminated materials using the present invention are not inclusive, and other materials could be used without departing from the principles of the present invention. This is particularly true with respect to some of the various shapes of corner construction and seal construction of seals that are described above. Moreover, the manufacturing process steps are certainly not dependent upon any particular materials used in the web or laminated paperboard material that is described in more detail above. Furthermore, the exact shapes of the various seals illustrated herein can be changed with respect to dimensional proportions, again without departing from the principles of the present invention.

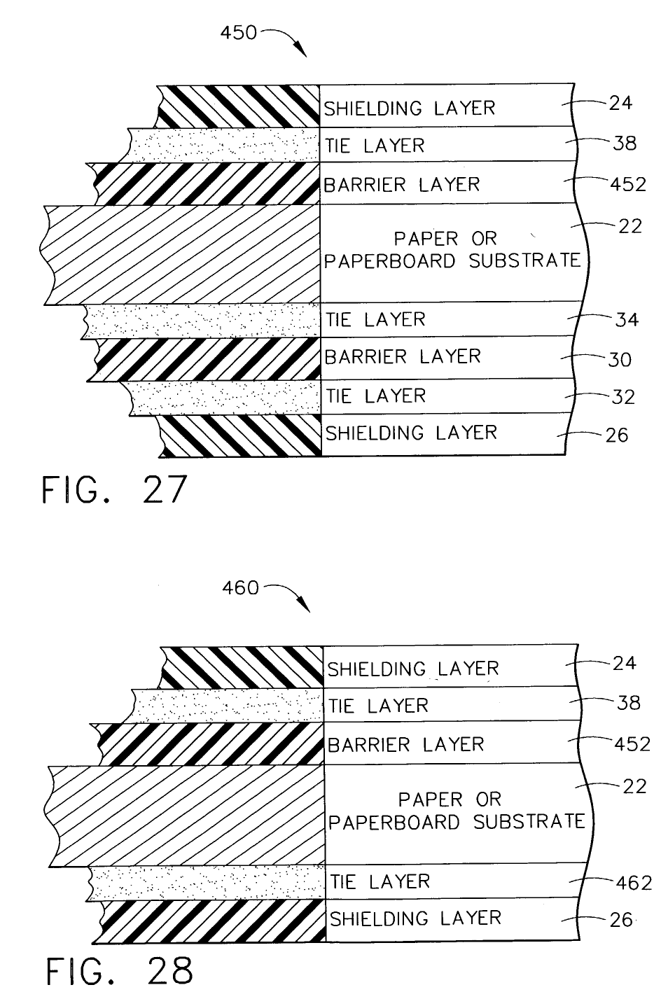

Further examples of laminate structures are illustrated in FIGS. 27 and 28. In FIG. 27, a laminated material generally designated by the reference numeral 450 includes most of the individual layers that were found in the laminate 20 depicted in FIG. 2. This includes two shielding layers 24 and 26 and two “outer” tie layers 32 and 38, as well as a paper or paperboard substrate 22. There is also a first barrier layer 30 that has an “inner” tie layer 34 that affixes first barrier layer 30 to the substrate 22. However, the second barrier layer 452 has no tie layer interposed between the substrate 22 and second barrier layer 452.

This laminate structure 450 can be accomplished, for example, by use of an extrudable nylon material for this second barrier layer 452. By coating the paper/paperboard substrate 22 with extrudable nylon, a tie layer may be eliminated as compared to laminate 20 (of FIG. 2). Examples of appropriate extrudable nylon barrier layers include a nylon layer that is 0.5 mils (0.005 inches) in thickness, or eight to ten pounds per ream (i.e., per 3000 square feet of laminate material). A “high barrier” nylon may be used for this purpose.

In FIG. 28, another laminated material generally designated by the reference numeral 460 also includes most of the individual layers that were found in the laminate 20 depicted in FIG. 2. This again includes two shielding layers 24 and 26, but only one “outer” tie layer 38, as well as a paper or paperboard substrate 22. There is only a single barrier layer 452 that, similar to the structure 450 in FIG. 27, has no tie layer interposed between the substrate 22 and second barrier layer 452. Moreover, the only other tie layer at 462 is interposed directly between the substrate 22 and one of the shielding layers at 26. In this laminate structure 460, the “second” barrier layer is missing completely, and thus the tie layer 462 is used to affix the shielding layer 26 directly to the paper/paperboard substrate 22. The material for tie layer 462 may be different than that of tie layer 38, but that depends upon the exact materials used for the various individual shielding layers 24, 26, barrier layer 452, and substrate 22.

It would be best if the shielding layer 26 for laminate structure 460 has some barrier characteristics, at least against moisture, and perhaps oxygen. A nylon film could be used for shielding layer 26 (see Example #12, below), or perhaps a layer of OUB-R film could be used (which is described below in greater detail).

As compared to the laminate structure 20 of FIG. 2, this alternative laminate 460 eliminates both a barrier layer and two tie layers. Of course the single barrier layer 452 must provide sufficient characteristics to reduce oxygen transmission, etc., and this barrier layer 452 should also have proper extrusion properties so as to be able to coat the paper or paperboard substrate 22 in a relatively fast manufacturing process to make this configuration a commercially viable one.

Another example of a spiral-wrapped construction is illustrated in FIG. 29, generally designated by the reference numeral 310, which is based upon the structure illustrated in FIG. 19. In FIG. 29, two different laminate materials are used as the “half-structures” that make up a “total” laminate that is used for the entire sidewall of the cylindrical container 310. The first laminate material is designated by the reference numeral 332 on one side of its spiral seam 320, and by the reference numeral 334 on the other side of its spiral seam 320. The second laminate material designated by the reference numeral 336 on one side of its spiral seam 322, and by the reference numeral 338 on the other side of its spiral seam 322. The first laminate is not precisely the same as the second laminate.

FIG. 29 depicts the various layers of the two “half-structures” that each consist of a laminate. For the laminate 332, the outer layer 308 is a shielding layer, the adjacent layer 306 is a tie layer, the next adjacent layer 304 is a barrier layer, and the main substrate layer 302 is a paper or paperboard layer. The layer 330 represents an adhesive, which will be discussed further, below.

For the laminate 336, the outer layer 348 is a shielding layer, the adjacent layer 346 is a tie layer, the next adjacent layer 344 is a barrier layer, the next further adjacent layer 342 is another tie layer, and the main substrate layer 340 is a paper or paperboard layer. When both of these half-structures 332 and 336 are spiral wrapped together, the two paper/paperboard layers 304 and 340 become adjacent to one another, separated only by the adhesive material at layer 330. This adhesive 330 is, of course, compatible with affixing the two paper/paperboard layers to one another, regardless as to whether or not the paper layer 304 is made of the precise same material as the other paper layer 340.

As can be seen from FIG. 29, the two half-structures 332 and 336 are not identical in structural form: the laminate 332 does not include a tie layer between its paper layer 302 and its barrier layer 304, while the laminate 336 does include a tie layer 342 between its paper layer 340 and its barrier layer 344. This is a situation in which the material used for the barrier layer 304 has been applied directly to the paper layer 302 without the need for an adhesive or sealant therebetween, such as the use of a nylon coating (e.g., at 8 pounds per ream) that has been extruded onto the paper layer 302. In this example of FIG. 29, the tie layer 342 is used along with a material for barrier layer 344 that, for example, could be a sheet of aluminum foil. Many other examples of half-structures are discussed below which could be used in such a spiral container, or in a convolute container.

Referring now to FIG. 30, the spiral tubular structure 310 is viewed from its end, clearly showing the adhesive layer 330 being located between the two paper layers 302 and 340. As can be seen on FIG. 30, the two paper layers 302, 340 end up comprising the middle layers of the “total” laminate 310, and the non-paper layers consist of 342, 344, 346, and 348 on the inner surface, while the non-paper layers on the outer surface consist of 304, 306, and 308.

As described above, the laminated structural material generally uses paper or paperboard material to provide strength and stiffness. Paper is structurally strong and stiff material when it is dry, and the general function of the shielding layer or material is to protect the paper structural layer from moisture during the retort process. To keep the structural integrity intact for the laminated material, the paper layer needs to be protected from moisture at all times. Therefore, the protection for the paper at the joints or seams is particularly important.

In one aspect of the present invention, the joints/seams are protected by a skiving and folding technique, and in this embodiment a uniform wall or laminated material thickness is maintained while the paper barrier layer remains shielded. At all times, the paper barrier remains as one of the inner layers, even at the joints, by using this inventive technique. At the same time, the shielding layers are always made to be the outside layers, and thus remain the only layers that come into contact with steam during the sterilization or retort process.

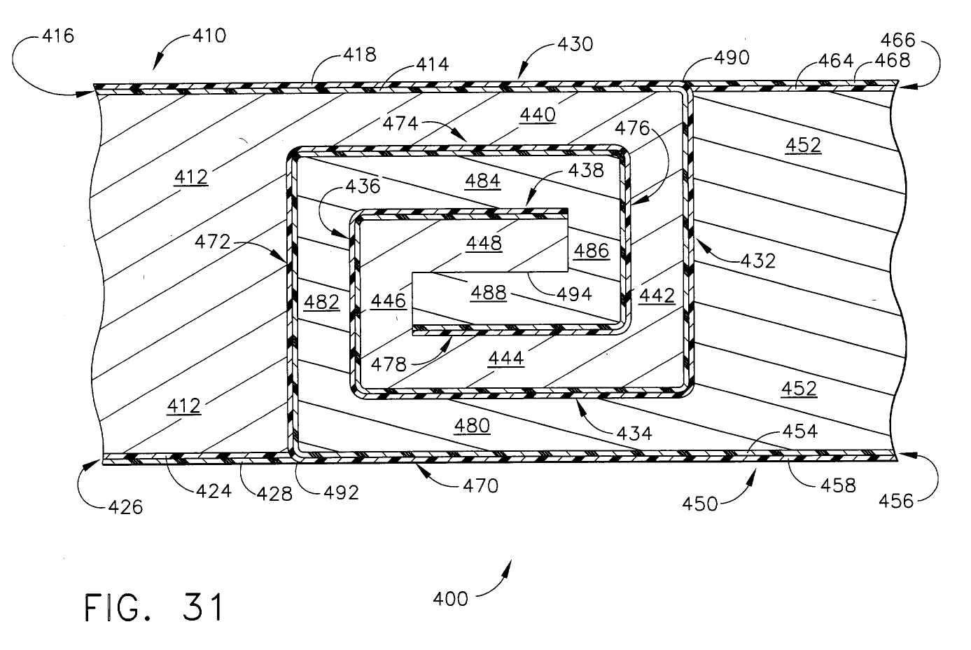

Referring now to FIG. 31, a side seam or body seam (e.g., for a longitudinal seal or a spiral seal) is illustrated, generally designated by the reference numeral 400. A left (in this view) laminated structure 410 arrives from the left side in this drawing, while a right (in this view) similar laminated material 450 arrives from the right side in this drawing. The “left” structure 410 includes an innermost structural layer 412, which generally is made of a paper or paperboard material.

In this particular embodiment, it is probably better if the laminated structure 410 is symmetrical, and from that standpoint this is in reference to the material and location of shielding layers 418 and 428, and barrier layers 414 and 424. In some of the embodiments described above, the “inner” and “outer” shielding layers were not always comprised of the same materials, and the same was true with respect to the barrier layers for the “inner” and “outer” portions of the laminated material. In fact, in some of the above-described embodiments, the barrier layer did not even exist on one of the “inner” or “outer” portions of the laminated structure. In the structure 400 of FIG. 31, the material will be skived, and thus the laminated material would probably be more useful if it was symmetrical from the standpoint of the types of barrier and shielding layers, and as such, either outer surface could be used as a protruding finger that will become part of the seam or joint. Alternatively, the layered-orientation and types of compounds used for the laminated material 400 could of course be made specific, and the shielding layers and barrier layers would not necessarily need to be symmetrical for both the inner and outer surfaces of the overall laminated material.

In the upper-left portion of FIG. 31, the shielding layer 418 and barrier layer 414 have a common surface at 416, which in general would comprise a tie layer that would normally consist of an adhesive material. This tie layer will run down the length of the protruding finger, which will be described below. A similar common surface or tie layer at 426 is formed between the shielding layer 428 and barrier layer 424 that are illustrated in the lower-left corner of FIG. 31.

A protruding finger is formed by skiving the left-hand member 410 of the body seam 400, and its initial rectangular segment (as seen on FIG. 31) is designated at the reference numeral 440, which exhibits the “outer” shielding and barrier layers at 430. This protruding finger continues after making a right angle change in direction, and becomes a rectangular member 442, still with its “outer” barrier and shielding layers at 432. After another change in direction at a right angle, the protrusion continues as a rectangular member 444, again with its “outer” barrier and shielding layers at 434. Continuing with another right angle change in direction, the protruding finger reaches a rectangular segment 446, having its “outer” barrier and shielding layers at 436. The final portion of the protruding finger is a rectangular member 448, which still has its “outer” shielding and barrier layers at 438.

The portion of the body seam 400 that arrives from the right (i.e., the member 450), includes a main structural layer 452, that generally will be made of a paper or paperboard material. This laminated material 450 includes an outermost shielding layer 468 and a barrier layer 464, separated by a common surface or a tie layer 466, as viewed in the upper-right portion of FIG. 31. A similar shielding layer 458 and barrier layer 454 are joined by a surface or tie layer at 456, in the bottom-right corner of FIG. 31.

This right-member 450 is skived in a similar manner to the left-member 410, and will thus exhibit a protruding finger that will be described next. The protruding finger after the skiving operation begins as a rectangular member 480, which exhibits an outer shielding and barrier layer at 470. The protruding finger continues after making a right angle change in direction as a rectangular member 482, also exhibiting an “outer” shielding and barrier layer at 472. After another right angle change in direction, the protruding finger continues as a rectangular member 484, which exhibits its “outer” barrier and shielding layers at 474, and this is followed by another right angle change in direction to a rectangular member 486 that exhibits its “outer” barrier and shielding layers at 476. A final rectangular member at 488 extends from the member 486 after making another right angle change in direction, and it also exhibits its “outer” shielding and barrier layers at 478.

It will be understood that the continuous barrier and shielding layers that follow the protruding fingers all the way to the innermost portions of this body seam 400 need not necessarily literally extend all the way to this innermost portion. If desired, the barrier and/or shielding layers could themselves be removed (e.g., by a skiving operation) along any portion of these protruding fingers once they make their first or initial right angle change of direction, thereby “aiming” toward the middle portions of the structural paper layers 412 or 452.

At the innermost portions of the body seam structure 400, the skived paper layers meet along a set of line segments 494, along their rectangular members 448, 446, 488, and 486. An adhesive material can be placed here if desired, although other adhesive contact can be made for this body seam that will likely keep these right-angle members joined together without an extra adhesive. The adhesive in the tie layers at the shielding and barrier layers may possibly be used for some of the structural integrity of the body seam 400, although the entire structure would have to be heated above the melting point of the adhesive in the tie layers, if this was to be a desired methodology for permanently joining the two half-members 410 and 450 together.

On the other hand, the shielding layers must be used to protect the inner paper substrate layers, and this means that the outer joints at 490 and 492 need to be sealed in a manner that the shielding layers are essentially continuous through these joints 490 and 492. One way to insure good structural integrity at these joints is to form the overall body seam structure at a seam-forming station, and while the members are held together mechanically, to also then raise the temperature of the entire structure above the melting point of either the shielding layer itself, or the tie layers that are in contact with the shielding layer at the barrier layers (i.e., the tie layers 466 and 426). In any event, it is important that the shielding layer in effect cover the entire joints at 490 and 492, thereby keeping the inner paper substrate layers protected from moisture during retort or sterilization procedures. Of course, the actual shape of body seam 400 can be much different than illustrated in FIG. 31 without departing from the principles of the present invention.

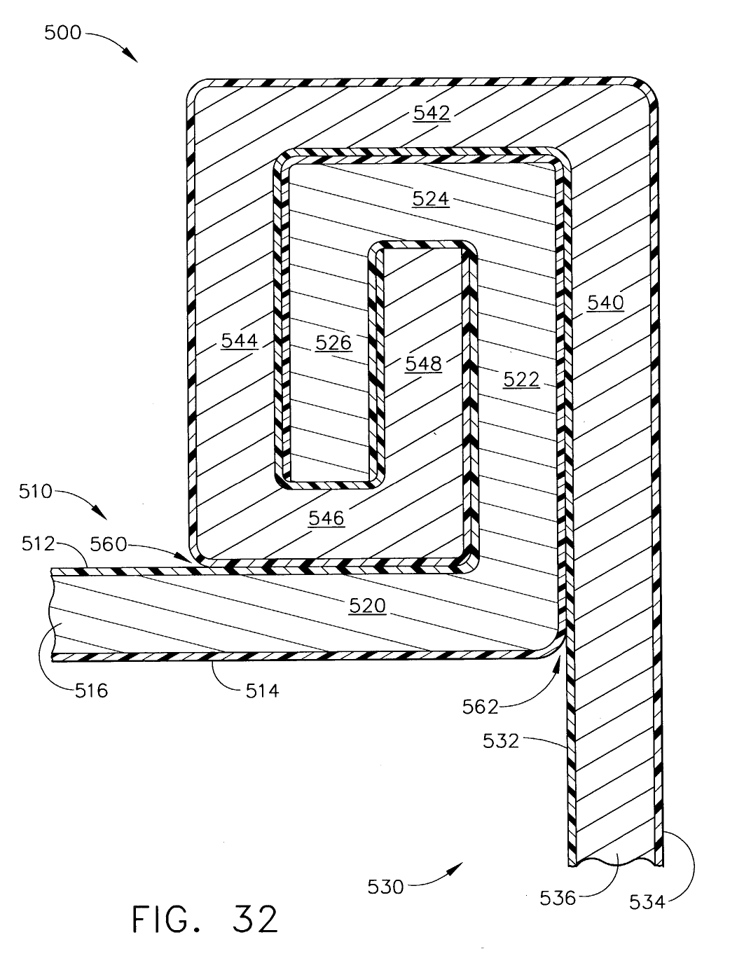

Referring now to FIG. 32, a corner or end seal (or joint) 500 is illustrated, and generally comprises a first laminated material structure 510 and a second similar laminated material structure 530. The laminated material structure 510 could comprise a lid of a retortable can, and in FIG. 32 includes an inner paper or structural layer 516, as well as outer shielding and/or barrier layers at 512 and 514. This laminated material continues into the joint along rectangular segments 520, 522, 524, and 526. As can be seen in FIG. 32, this laminated material that makes up the member 510 is not necessarily skived to make this end seal.

The other structural member 530 also is made of a laminated material, which includes an inner structural layer 536 (made of paper or paperboard in a preferred embodiment), and also includes outer shielding and/or barrier layers at 532 and 534. This laminated material of member 530 continues along rectangular segments 540, 542, 544, 546, and 548.

As in all of the laminated materials used in the present invention to make retortable cans, generally it is important to keep the inner structural layers dry, particularly if they are made of a paper or paperboard material. Therefore, the “joints” where the two members 510 and 530 meet need to be maintained as liquid-tight joints (i.e., as seals), and also protective against steam used in many sterilization or retort chambers. These joints/seals 560 and 562 can comprise a separate adhesive, if desired, or in another form of this embodiment, these joints/seals could comprise the shielding layers themselves, if such shielding layers are also capable of acting as an adhesive when they are raised above their melting temperature and allowed to flow from one of the members 510 to the other member 530, for example. When cooled, the shielding layers could then form a continuous liquid-tight and steam-protective joint/seal at these locations 560 and 562.

Additional detailed examples of materials that may be used in the laminate structures of the present invention are presented below. As in the above examples, the first (left-most) material listed represents the outermost layer, while the last (right-most) material listed represents the innermost layer. In the listings below, the abbreviations used have the following meanings:

S=shielding layer

B=barrier layer

P=paper or paperboard layer

T=tie layer

### EXAMPLE #1

S/T1/P/T2/B/T3/S, where:

Both S are a moisture protective layer, e.g., high crystalline PP (HCPP);

T1 and T2 are tie layers made of maleic anhydride modified polyolefin;

T3 is a tie layer made of: ethylene, acrylic ester, or maleic anhydride terpolymers;

P is made of: 10 point cupstock or 10 point Kraftboard (i.e., 10 points=10 mils=0.010 inches);

B is an oxygen barrier layer made of: EVOH, Am Nylon, PET-LCP, Al foil, metalized PET, SiOₓ, or PET; or

B may also have a “rigidity” enhancement property, made of: Nylon 6-6, CPET, PET-PEN, or PET-LCP.

### EXAMPLE #2

S/T/B1P/T/B2/T/S, where:

Both S are 1 mil HCPP;

T are any appropriate tie layer material;

The outer B is nylon;

P is any appropriate paper;

The inner B is Al foil, 0.00028 inches thick.

### EXAMPLE #3

S/T/B1/P/T/B2/T/S, where:

Both S are 12-16 pounds/ream HCPP;

T are any appropriate tie layer material;

B1 is nylon;

P is any appropriate paper;

B2 is Al foil, 0.00028 inches thick.

### EXAMPLE #4

S/T/B1/P/T/B2/T/S, where:

Both S are 1 mil HCPP;

T are any appropriate tie layer material;

B1 is 0.5 mil nylon;

P is 12 point paper;

B2 is Al foil, 0.00028 inches thick.

### EXAMPLE #5

S/T/B1/P/T/B2/T/S, where:

Both S are 1 mil, or 12-16 pounds/ream HCPP;

T are 0.5 mil or 3-5 pounds/ream of any appropriate tie layer material;

B1 is 0.5 mil or 8-10 pounds/ream nylon;

P is 16 point paper;

B2 is Al foil, 0.00028 inches thick.

### EXAMPLE #6

S/T/B1/P/T/B2/T/S, where:

Both S are 1 mil, or 12-16 pounds/ream HCPP;

T are 0.5 mil or 3-5 pounds/ream of any appropriate tie layer material;

B1 is 0.5 mil or 8-10 pounds/ream high barrier nylon;

P is 16 point paper;

B2 is Al foil, 0.00028 inches thick.

### EXAMPLE #7

S/T/B1/P/B2/T/B3/T/S, where:

Both S are 12-16 pounds/ream HCPP;

T are 3-5 pounds/ream of any appropriate tie layer material;

B1 and B2 are 8-10 pounds/ream high barrier nylon;

P is 16 point Everest Cup stock;

B3 is 70 gauge metalized PP.

### EXAMPLE #8

S/Ti/B1/P/T2/B2/T3/S, where:

Both S are 12-16 pounds/ream PP (Montell PF 611);

T1 and T3 are 3-5 pounds/ream Morton Tymor 2205;

B1 is 8-10 pounds/ream nylon (Allied Capron 2120 FN);

P is 20 point Everest Cup stock paper CS 1357;

T2 is 5-8 pounds/ream Dow Primacor 3460;

B2 is Al foil, 0.00028 inches thick.

### EXAMPLE #9

S/T/B1/P/T2B2/T3/S, where:

Both S are 14 pounds/ream PP;

T1 and T3 are 3 pounds/ream of any appropriate tie layer material;

B1 is 8 pounds/ream nylon;

P is 210 pounds/ream paperboard;

T2 is 5 pounds/ream of any appropriate tie layer material;

B2 is 12 pounds/ream Al foil.

### EXAMPLE #10

S/T1/B1/T2/P/B2/T3/S, where:

Both S are 16 pounds/ream PP;

T1 is 5 pounds/ream of any appropriate tie layer material;

B1 is Al foil, 0.00028 inches thick;

T2 is 8 pounds/ream of any appropriate tie layer material;

P is 20 point paperboard;

B2 is 10 pounds/ream nylon;

T3 is 3 pounds/ream of any appropriate tie layer material.

### EXAMPLE #11

S1/T/B1/P/B2/S2, where:

S1 is 16 pounds/ream PP;

T is 5 pounds/ream of any appropriate tie layer material;

B1 is 10 pounds/ream nylon;

P is 20 point paperboard;

B2 is 12 is Al foil, 0.00028 inches thick;

S2 is OUB-R nylon film (Allied Signal).

### EXAMPLE #12

S1/T/B/P/T/S2, where:

S1 is HCPP;

T are any appropriate tie layer material;

B is nylon;

P is any appropriate paper;

S2 is nylon film.

As noted above, some of the laminate materials can be formed from two “half-structures” that each consist of a laminate that has a paper or paperboard layer at one of its outer surfaces, and which are spiral wound and affixed into position during the spiral tube-forming operation. The paper/paperboard layer of the first component (half-structure) is placed adjacent to the paper/paperboard layer of the second component (half-structure), and an adhesive material is applied between these two paper/paperboard layers. Examples of such half-structures are as follows:

### EXAMPLE #13

S/T/B/P, where:

S is PP;

T is any appropriate tie layer material;

B is nylon;

P is any appropriate paper.

### EXAMPLE #14

P/T/B/T/S, where:

P is any appropriate paper;

T are any appropriate tie layer material;

B is Al foil;

S is PP.

### EXAMPLE #15

P/T/B, where:

P is any appropriate paper;

T is any appropriate tie layer material;

B is nylon.

### EXAMPLE #16

P/T/B/T/S, where:

P is any appropriate paper;

T are any appropriate tie layer material;

B is a blend of PET and LCP;

S is PP.

### EXAMPLE #17

P/B/T/S, where:

P is 12 point paperboard;

B is 10 pounds/ream nylon;

T is 3 pounds/ream of any appropriate tie layer material;

S is 16 pounds/ream PP.

### EXAMPLE #18

S/T1/B/T2/P, where:

S is 16 pounds/ream PP;

T1 is 3 pounds/ream of any appropriate tie layer material;

B is Al foil, 0.00028 inches thick;

T2 is 8 pounds/ream of any appropriate tie layer material;

P is 12 point paperboard.

### EXAMPLE #19

P/B/S, where:

P is 12 point paperboard;

B is 12 pounds/ream nylon;

S is OUB-R film.

### EXAMPLE #20

P/T/B/T/S, where:

P is 12 point paperboard;

T are 3 pounds/ream of any appropriate tie layer material;

S is 16 pounds/ream PP.

### EXAMPLE #21

P/T/B/T/S, where:

P is 12 point paperboard;

T are 3 pounds/ream of any appropriate tie layer material;

B is 10 pounds/ream PET-PEN;

S is 16 pounds/ream PP.

### EXAMPLE #22

Note that if one uses the laminate of Example # 13 as the first half-structure along with the laminate of Example #16 as the second half-structure, the total combination after being spiral-wrapped would have the following structure:

S1/T/B1/P1/A/P2/T/B2/T/S2, where:

A is an adhesive layer between the two paper substrate layers P1 and P2.

### EXAMPLE #23

S/T1/B1/P/T2/B2/T3/S, where:

S are each 16 pounds/ream PP—Montell PF 611;

T1 is 3 pounds/ream—Morton Tymore 2205;

B1 is 10 pounds/ream nylon—Allied Capron 2120 FN;

P is 20 point Everest Cupstock paperboard—International Paper CS 1394;

T2 is 8 pounds/ream—Morton Tymore 2205;

B2 is Al foil, 0.00028 inches thick;

T3 is 5 pounds/ream—Morton Tymore 2205.

The above notation about OUB-R film refers to a three-layer film produced by Allied Signal Inc., which is described in detail in U.S. Pat. No. 5,547,765. The three layers essentially consist of a first outer nylon layer, a blend of nylon and EVOH, and a second outer nylon layer. If this OUB-R film is used on the side of the laminate that contacts the (food) product, then the film can act as a shielding layer. In fact, the three layers of the OUB-R film can essentially be viewed as three individual shielding layers; or the three layers of OUB-R can alternatively be viewed as a shielding layer (which would be placed at the surface of the overall laminate structure), and two “inner” barrier layers. Certainly the middle layer of OUB-R will act as an oxygen barrier, mainly due to the EVOH in the blend of nylon and EVOH of this middle layer.

As noted above, nylon can be applied to paperboard without use of a tie layer. Moreover, OUB-R film can be laminated to a nylon layer without use of a tie layer. Notations above for PET-PEN, or PET-LCP refer to a blend of the two resins that are applied as a single layer, where indicated.

Another material that can be used in the shielding layers is high density polypropylene (HDPP). This could be used in many of the above-described embodiments that include other forms of polypropylene, such as in lieu of polypropylene in the above Examples #9, #10, or #11. In Example #8, perhaps HDPP could be used in lieu of the Montell PF 611. HDPP could also be used in shielding layers for the “half-structures” that are described in Examples #13, #14, #16, #17, #18, #20, #21, and #23.

The various material layers used in the present invention will often require different tie layer materials depending, for example, upon the precise materials used for the barrier or shielding layers. In general, a tie material or resin is used as an adhesive to chemically bond two adjacent layers, each of which have different end-group chemical functionality. Some common examples are provided below, and represent fairly common practice to those skilled in the art. These below examples first list the type of tie layer material, and then the types of adjacent layers materials:

### EXAMPLE A:

Tie material: maleic anhydride modified polyolefin (MAPP);

used between: non-polar PP and polar paperboard.

### EXAMPLE B

Tie material: ethylene acrylic ester;

or ethylene methacrylic acid with metal neutralization;

or ethylene methacrylic acid without metal neutralization;

used between: paper and Al foil.

### EXAMPLE C

Tie material: maleic anhydride polypropylene;

used between: nylon and PP.

### EXAMPLE D

Tie material: ethylene-methyl acrylate-glycidyl methacrylate (E-MA-GMA) terpolymer;

used between: paper and PET.

It will be understood that in all cases, the product contact layer must have a shielding functionality, and that the use of certain materials will allow the product contact layer to also serve a dual purpose of providing a barrier functionality. An example of this configuration is given above in Example #12, in which a nylon film acts as both the inner shielding layer and a barrier layer between the paper substrate and the product.

The above Examples #1 through #23 have all been constructed as prototypes by the inventors and tested for retort conditions, and each of these Examples ##1-23 are able to withstand retort conditions. It will be understood that two primary factors will need to be considered before determining which precise construction will be used for manufacturing the final retortable can or container: (1) the cost of the materials making up the laminate structure, and (2) the ease of manufacturing such materials into the laminate structure. Of course, the “ease” of manufacturing involves its own set of factors, and capital equipment cost is always a consideration, but also the speed of the process will be balanced against the equipment cost.

If a very thick paperboard material is desired (or necessary) to contain a particular product, then certain shapes and sizes may not be an option. For example, the bending stresses to form the longitudinal (or side) seal as depicted in FIG. 3 may be greater than the bending stresses to form a spiral or convolute tube of a particular diameter.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

The invention claimed is:

1. A retortable container, comprising:
a laminated material forming a substantially hollow cylinder, a first substantially circular end member, and a second substantially circular end member;
said first end member being attached to said cylinder in a manner so as to make a liquid-tight seal at first locations of attachment; and
said second end member being attached to said cylinder in a manner so as to make a liquid-tight seal at second locations of attachment;
wherein said laminated material comprises: (a) a first layer substantially comprising a first shielding material that is resistant to heat and moisture; (b) a second layer substantially comprising a paper material; (c) a third layer substantially comprising a first barrier material that reduces a rate of transmission of oxygen, moisture, and flavor; (d) a fourth layer substantially comprising a second shielding material that is resistant to heat and moisture; and (e) an adhesive material that substantially holds said first, second, third, and fourth layers in place with respect to one another.

2. The retortable container as recited in claim 1, wherein the individual materials used in said laminated material are each capable of withstanding retort conditions of 121° C. for 60 minutes at 15 PSI pressure.

3. The retortable container as recited in claim 1, further comprising: a fifth layer substantially comprising a second barrier material that reduces a rate of transmission of oxygen, moisture, and flavor; and said fifth layer being placed between said first layer and said second layer.

4. The retortable container as recited in claim 1, further comprising: a food product that is placed within said container after said first end member has been attached to said laminated material, but before said second end member is attached to said laminated material; and wherein said fourth layer is compatible with direct food contact.

5. The retortable container as recited in claim 1, wherein said laminated material, starting substantially as a planar sheet, is wrapped substantially in a spiral tube to construct said substantially hollow cylinder shape.

6. The retortable container as recited in claim 1, wherein said laminated material, starting substantially as a planar sheet, is curved such that two of its edges are brought proximal to one another and a longitudinal seal is made, thereby forming said substantially hollow cylinder shape.

7. The retortable container as recited in claim 6, wherein said two edges of the laminated material are skived before being joined into said longitudinal seal, and wherein at least one of said first shielding material and said second shielding material aids in providing a liquid-tight characteristic and a steam-resistant characteristic at said longitudinal seal, such that said paper material is substantially protected from exterior liquid and steam.

8. The retortable container as recited in claim 1, wherein at least one of said first shielding material and said second shielding material aids in providing a liquid-tight characteristic and a steam-resistant characteristic at said first and second locations of attachment, such that said paper material is substantially protected from exterior liquid and steam.

9. The retortable container as recited in claim 1, wherein at least one of said first and second shielding materials comprises one of: amorphous nylon; nylon-6; nylon-6,6; a moisture resistant blend of nylon and PP; CPET; PEN; a blend of PET-PEN; HCPP; HDPP; PET; moisture resistant polyester; PP; moisture resistant PET; Aluminum foil; high barrier nylon; metalized PP; and a blend of PET-LCP.

10. The retortable container as recited in claim 1, wherein at least one of said first and second barrier materials comprises one of: amorphous nylon; a blend of EVOH-amorphous nylon; LCP; an alloy of PET-LCP; nylon-6,6; HCPP; HDPP; EVOH; SiOₓ; AlₓO_{y}; PET with metalized Al; and nylon layered film.

11. The retortable container as recited in claim 1, wherein said adhesive material between the various of said layers comprises at least one of: maleic anhydride modified polyolefin; ethylene acrylic ester; maleic anhydride terpolymers; Morton Tymor 2205; Dow Primacor 3460; ethylene methacrylic acid with metal neutralization; ethylene methacrylic acid without metal neutralization; maleic anhydride polypropylene; and ethylene-methyl acrylate-glycidyl methacrylate (E-MA-GMA) terpolymer.

12. A laminate material usable as a structural member of a retortable container, said material comprising:
(a) a first layer substantially comprising a first shielding material that is sufficiently resistant to heat and moisture to withstand direct contact with steam and retort conditions of 121° C. for 60 minutes at 15 PSI pressure;
(b) a second layer substantially comprising a paper material, that is sufficiently resistant to heat to withstand 121° C. for 60 minutes at 15 PSI pressure;
(c) a third layer substantially comprising a first barrier material that reduces a rate of transmission of oxygen, moisture, and flavor, and that is sufficiently resistant to heat to withstand 121° C. for 60 minutes at 15 PSI pressure; and
(d) a fourth layer substantially comprising a second shielding material that is sufficiently resistant to heat and moisture to withstand retort conditions of 121° C. for 60 minutes at 15 PSI pressure, and is compatible with direct food contact.

13. The laminate material as recited in claim 12, wherein the individual materials used in said laminated material are each capable of withstanding retort conditions of 121° C. for 60 minutes at 15 PSI pressure.

14. The laminate material as recited in claim 12, further comprising: a fifth layer substantially comprising a second barrier material that reduces a rate of transmission of oxygen, moisture, and flavor; and said fifth layer being placed between said first layer and said second layer.

15. The laminate material as recited in claim 12, wherein at least one of said first and second shielding materials comprises one of: amorphous nylon; nylon-6; nylon-6,6; a moisture resistant blend of nylon and PP; CPET; PEN; a blend of PET-PEN; HCPP; HDPP; PET; moisture resistant polyester; PP; moisture resistant PET; Aluminum foil; high barrier nylon; metalized PP; and a blend of PET-LCP.

16. The laminate material as recited in claim 12, wherein at least one of said first and second barrier materials comprises one of: amorphous nylon; a blend of EVOH-amorphous nylon; LCP; an alloy of PET-LCP; nylon-6,6; HCPP; HDPP; EVOH; SiOₓ; AlₓO_{y}; PET with metalized Al; and nylon layered film.

17. The laminate material as recited in claim 14, further comprising: a first tie layer between said first layer of shielding material and said fifth layer of barrier material; a second tie layer between said second layer of paper material and said third layer of barrier material; and a third tie layer between said third layer of barrier material and said fourth layer of shielding material;
wherein said fifth layer of barrier material comprises extrudable nylon that adheres directly to said second layer of paper material without a tie layer therebetween; and
wherein said first tie layer, said second tie layer, and said third tie layer each are sufficiently resistant to heat to withstand 121° C. for 60 minutes at 15 PSI pressure.

18. The laminate material as recited in claim 12, further comprising: a first tie layer between said first layer of shielding material and said second layer of paper material; a second tie layer between said second layer of paper material and said third layer of barrier material; and a third tie layer between said third layer of barrier material and said fourth layer of shielding material;
wherein said first tie layer, said second tie layer, and said third tie layer each are sufficiently resistant to heat to withstand 121° C. for 60 minutes at 15 PSI pressure.

19. The laminate material as recited in claim 17, wherein a material for said tie layers between the various of said layers comprises at least one of: maleic anhydride modified polyolefin; ethylene acrylic ester; maleic anhydride terpolymers; Morton Tymor 2205; Dow Primacor 3460; ethylene methacrylic acid with metal neutralization; ethylene methacrylic acid without metal neutralization; maleic anhydride polypropylene; and ethylene-methyl acrylate-glycidyl methacrylate (E-MA-GMA) terpolymer.

20. The laminate material as recited in claim 19, wherein a material for said tie layers between the various of said layers comprises at least one of: maleic anhydride modified polyolefin; ethylene acrylic ester; maleic anhydride terpolymers; Morton Tymor 2205; Dow Primacor 3460; ethylene methacrylic acid with metal neutralization; ethylene methacrylic acid without metal neutralization; maleic anhydride polypropylene; and ethylene-methyl acrylate-glycidyl methacrylate (E-MA-GMA) terpolymer.

21. A method for forming a retortable container, comprising:
providing a web of laminated material, said laminated material having multiple layers of materials of different properties, in order from a first surface toward a second surface: (a) a first layer substantially comprising a first shielding material that is resistant to heat and moisture; (b) a second layer substantially comprising a first barrier material that reduces a rate of transmission of oxygen, moisture, and flavor; (c) a third layer substantially comprising a paper material; and (d) a fourth layer substantially comprising a second shielding material that is resistant to heat and moisture;
moving said web of laminated material through a skiving station to form longitudinal edges in the web that are shaped for being more readily affixed;
moving said web of laminated material through a continuous tube forming station which wraps said web into a shape of a substantially hollow cylinder and applies an adhesive to hold said web in its substantially hollow cylindrical shape;
cutting said web of laminated material into a plurality of hollow cylinders of a predetermined length, each of said hollow cylinders having a first open end and a second open;
attaching a bottom lid to said hollow cylinders at said first open end;
filling said hollow cylinders with a product through said second open end; and
attaching a top lid to said hollow cylinders at said second open end.

22. The method as recited in claim 21, wherein the individual materials used in said laminated material are each capable of withstanding retort conditions of 121° C. for 60 minutes at 15 PSI pressure.

23. The method as recited in claim 21, wherein the step of wrapping said web into the shape of a substantially hollow cylinder comprises: forming said web of laminated material substantially into a spiral tube.

24. The method as recited in claim 21, wherein the step of wrapping said web into the shape of a substantially hollow cylinder comprises: curving said web such that its two skived longitudinal edges are brought proximal to one another; and wherein said step of applying an adhesive comprises: making a longitudinal seal.

25. The method as recited in claim 21, wherein the step of wrapping said web into the shape of a substantially hollow cylinder comprises: curving said web such that its two skived longitudinal edges are brought proximal to one another; and wherein said step of applying an adhesive utilizes at least one of said first shielding material and said second shielding material, which aid in providing a liquid-tight characteristic and a steam-resistant characteristic at said longitudinal edges, such that said paper material is substantially protected from exterior liquid and steam.

26. The method as recited in claim 21, wherein, during said steps of attaching a bottom lid and attaching a top lid to said hollow cylinders, at least one of said first shielding material and said second shielding material aids in providing a liquid-tight characteristic and a steam-resistant characteristic at said first and second open ends, such that said paper material is substantially protected from exterior liquid and steam.

27. The method as recited in claim 21, further comprising the step of: adding a fifth layer between said first layer and said second layer, said fifth layer being substantially comprising a second barrier material that reduces a rate of transmission of oxygen, moisture, and flavor.

28. The method as recited in claim 21, wherein at least one of said first and second shielding materials comprises one of: amorphous nylon; nylon-6; nylon-6,6; a moisture resistant blend of nylon and PP; CPET; PEN; a blend of PET-PEN; HCPP; HDPP; PET; moisture resistant polyester; PP; moisture resistant PET; Aluminum foil; high barrier nylon; metalized PP; and a blend of PET-LCP.

29. The method as recited in claim 21, wherein at least one of said first and second barrier materials comprises one of: amorphous nylon; a blend of EVOH-amorphous nylon; LCP; an alloy of PET-LCP; nylon-6,6; HCPP; HDPP; EVOH; SiOₓ; AlₓO_{y}; PET with metalized Al; and nylon layered film.

30. A laminate material usable as a structural member of a retortable container, said laminate material comprising:
(a) a first layer substantially comprising a first shielding material that is sufficiently resistant to heat and moisture to withstand direct contact with steam and retort conditions of 121° C. for 60 minutes at 15 PSI pressure;
(b) a second layer substantially comprising a barrier material that reduces a rate of transmission of oxygen, moisture, and flavor, and that is sufficiently resistant to heat to withstand 121° C. for 60 minutes at 15 PSI pressure;
(c) a third layer substantially comprising a paper material, that is sufficiently resistant to heat to withstand 121° C. for 60 minutes at 15 PSI pressure; and
(d) a fourth layer substantially comprising a second shielding material that is sufficiently resistant to heat and moisture to withstand retort conditions of 121° C. for 60 minutes at 15 PSI pressure, and is compatible with direct food contact;
wherein said second layer of barrier material comprises extrudable nylon that adheres directly to said second layer of paper material without a tie layer therebetween.

31. The laminate material as recited in claim 30, further comprising: a first tie layer between said first layer of shielding material and said second layer of barrier material; and a second tie layer between said third layer of paper material and said fourth layer of shielding material; wherein said first tie layer and said second tie layer each are sufficiently resistant to heat to withstand 121° C. for 60 minutes at 15 PSI pressure.

32. The laminate material as recited in claim 30, wherein said fourth layer also comprises a sufficient barrier to oxygen, moisture, and flavor transmission so as to prevent said third layer from failing during a retort procedure.

33. The laminate material as recited in claim 32, wherein said fourth layer comprises one of: a nylon film, and OUB-R film.

34. The laminate material as recited in claim 31, wherein said tie layers comprise at least one of: maleic anhydride modified polyolefin; ethylene acrylic ester; maleic anhydride terpolymers; Morton Tymor 2205; Dow Primacor 3460; ethylene methacrylic acid with metal neutralization; ethylene methacrylic acid without metal neutralization; maleic anhydride polypropylene; and ethylene-methyl acrylate-glycidyl methacrylate (E-MA-GMA) terpolymer.

35. A method for forming a hollow tube of laminated material used in a retortable container, comprising:
providing a first web of laminated material, said first web of laminated material having multiple layers of materials of different properties, in order from a first surface toward a second surface: (a) a layer substantially comprising a paper material; and (b) at least one layer comprising: at least one of (i) a first shielding material that is resistant to heat and moisture, and (ii) a first barrier material that reduces a rate of transmission of oxygen, moisture, and flavor;
providing a second web of laminated material, said second web of laminated material having multiple layers of materials of different properties, in order from a third surface toward a fourth surface: (a) a layer substantially comprising a paper material; and (b) at least one layer comprising: at least one of (i) a second shielding material that is resistant to heat and moisture, and (ii) a second barrier material that reduces a rate of transmission of oxygen, moisture, and flavor;
moving said first and second webs to a forming station, and directing said first and second webs into an orientation such that said first surface of said first web is proximal to said third surface of said second web; and
applying an adhesive to at least one of said first surface of said first web and said third surface of said second web, and pressing said first and third surfaces together while wrapping said first web and said second web so as to form a substantially hollow tube of laminated material.

36. The method as recited in claim 35, wherein said step of wrapping the first and second webs results in one of: (a) a spiral construction; and (b) a convolute construction.

37. The method as recited in claim 35, wherein said first and second shielding materials are one of: (a) two different materials; and (b) an identical material.

38. The method as recited in claim 35, wherein said first and second barrier materials are one of: (a) two different materials; and (b) an identical material.

39. The method as recited in claim 35, further comprising the steps of:
(a) before wrapping, moving said first and second webs through a skiving station to form longitudinal edges in the webs, which thereby become shaped for being more readily affixed;
(b) after wrapping, cutting said substantially hollow tube of laminated material into a plurality of hollow constructions of a predetermined length, each of said hollow constructions having a first open end and a second open end;
(c) attaching a bottom lid to said hollow constructions at said first open end;
(d) filling said hollow constructions with a product through said second open end; and
(e) attaching a top lid to said hollow constructions at said second open end.

40. The method as recited in claim 39, further comprising the step of: after moving said first and second webs through said skiving station, utilizing at least one of said first shielding material and said second shielding material to aid in providing a liquid-tight characteristic and a steam-resistant characteristic to at least one of said first and second webs, such that said layers of paper material are substantially protected from exterior liquid and steam.

41. The method as recited in claim 39, further comprising the step of: during said steps of attaching said bottom lid and said top lid to said hollow constructions, at least one of said first shielding material and said second shielding material aids in providing a liquid-tight characteristic and a steam-resistant characteristic at said first and second open ends, such that said layers of paper material are substantially protected from exterior liquid and steam.

42. A laminate material usable as a structural member of a retortable container, said laminate material comprising:
(a) a first half-structure which comprises:
(i) a first layer substantially comprising a paper material; and
(ii) a second layer comprising at least one of (A) a first shielding material that is resistant to heat and moisture, and (B) a first barrier material that reduces a rate of transmission of oxygen, moisture, and flavor;
(b) a second half-structure which comprises:
(i) a third layer substantially comprising a paper material; and
(ii) a fourth layer comprising at least one of (A) a second shielding material that is resistant to heat and moisture, and (B) a second barrier material that reduces a rate of transmission of oxygen, moisture, and flavor; and
(c) a layer of adhesive material located between said first layer and said third layer, which affixes said first half-structure to said second half-structure.

43. The laminate material as recited in claim 42, wherein said first and second shielding materials are one of: (a) two different materials; and (b) an identical material.

44. The laminate material as recited in claim 42, wherein said first and second barrier materials are one of: (a) two different materials; and (b) an identical material.

45. The laminate material as recited in claim 42, wherein the individual materials used in said laminate material are each capable of withstanding retort conditions of 121° C. for 60 minutes at 15 PSI pressure.

46. The laminate material as recited in claim 42, wherein said first and second shielding materials are selected from at least one of: amorphous nylon; nylon-6; nylon-6,6; a moisture resistant blend of nylon and PP; CPET; PEN; a blend of PET-PEN; HCPP; HDPP; PET; moisture resistant polyester; PP; moisture resistant PET; Aluminum foil; high barrier nylon; metalized PP; and a blend of PET-LCP.

47. The laminate material as recited in claim 42, wherein said first and second barrier materials are selected from at least one of: amorphous nylon; a blend of EVOH-amorphous nylon; LCP; an alloy of PET-LCP; nylon-6,6; HCPP; HDPP; EVOH; SiOₓ; AlₓO_{y}; PET with metalized Al; and nylon layered film.

48. The laminate material as recited in claim 42, wherein various of said layers of material are affixed to one another by at least one tie layer, and said at least one tie layer comprises at least one of: maleic anhydride modified polyolefin; ethylene acrylic ester; maleic anhydride terpolymers; Morton Tymor 2205; Dow Primacor 3460; ethylene methacrylic acid with metal neutralization; ethylene methacrylic acid without metal neutralization; maleic anhydride polypropylene; and ethylene-methyl acrylate-glycidyl methacrylate (E-MA-GMA) terpolymer.

49. A packaging laminate for a retortable packaging container, comprising:
a core layer;
outer, liquid-tight coatings; and
a gas barrier disposed between said core layer and one of said outer coatings; wherein said gas barrier is bonded to said core layer by a layer of a lamination or sealing agent which has a higher melting point than the maximum temperature to which the retortable packaging container is to be subjected during a heat treatment in a retort.

50. The packaging laminate as recited in claim 49, wherein the lamination or sealing agent in said lamination/sealing agent layer has a melting point above 130° C.

51. The packaging laminate as recited in claim 49, wherein the lamination or sealing agent in said lamination/sealing agent layer comprises polypropylene.

52. The packaging laminate as recited in claim 49, wherein said core layer comprises paper.

53. The packaging laminate as recited in claim 49, wherein said core layer comprises paperboard.

54. The packaging laminate as recited in claim 49, wherein said gas barrier comprises aluminum foil.

55. The packaging laminate as recited in claim 49, wherein said sealing agent which comprises at least one of: maleic anhydride modified polyolefin; ethylene acrylic ester; maleic anhydride terpolymers; Morton Tymor 2205; Dow Primacor 3460; ethylene methacrylic acid with metal neutralization; ethylene methacrylic acid without metal neutralization; maleic anhydride polypropylene; and ethylene-methyl acrylate-glycidyl methacrylate (E-MA-GMA) terpolymer.
